(19) United States
(12) Patent Application Publication
(10) Pub. No.: US 2024/0228783 A1
(43) Pub. Date: Jul. 11, 2024

(54) ASPHALT BINDERS WITH PHENOL-RICH OILS

(71) Applicants: Elham Fini, Phoenix, AZ (US); Farideh Pahlavan, Tempe, AZ (US)

(72) Inventors: Elham Fini, Phoenix, AZ (US); Farideh Pahlavan, Tempe, AZ (US)

(21) Appl. No.: 18/410,633

(22) Filed: Jan. 11, 2024

Related U.S. Application Data
(60) Provisional application No. 63/479,460, filed on Jan. 11, 2023.

(51) Int. Cl. C08L 95/00; C08K 5/13

(52) U.S. Cl. CPC C08L 95/00; C08K 5/13; C08L 2555/64

(57) ABSTRACT

A bio-modified asphalt binder includes an asphalt binder and a phenol-rich oil. The phenol-rich oil can be a bio-oil. Examples of suitable sources for the bio-oil include pine bark, walnut shells, peanut shells, coconut husks, birch, and fir. The bio-modified asphalt binder increases durability and decreases long term oxidative damage compared with unmodified asphalt binder. A bio-modified asphalt includes the bio-modified asphalt binder and aggregate material and can be used in building materials such as pavement, roads, and roofing materials.

### CROSS-REFERENCE TO RELATED APPLICATION

This application claims the benefit of U.S. Patent Application No. 63/479,460, filed on Jan. 11, 2023, which is incorporated herein by reference in its entirety.

### STATEMENT OF GOVERNMENT SUPPORT

This invention was made with government support under 1928795 and 1928807 awarded by National Science Foundation. The government has certain rights in the invention.

### TECHNICAL FIELD

This invention relates to asphalt binders with phenol-rich oils.

### BACKGROUND

Asphalt binder is used as an adhesive to hold aggregate materials together, to form bituminous composites used in roads, airports, bridge decks, and roofing materials. The organic nature of asphalt binder makes it susceptible to chemical aging during its service life in outdoor settings. The chemical aging of asphalt binder is generally thought to be a result of irreversible polymerization, oxidation reactions, and the evaporation of lighter components. Oxidative aging is one of the factors contributing to the deterioration of an asphalt binder's mechanical properties and performance. The oxidation process causes hardening of asphalt binder, which consequently leads to premature cracking. Oxidation transforms asphalt binder from being soft and ductile to being brittle, stiff, and no longer sufficiently flexible to accommodate pavement stresses, leading to various distresses and eventually to pavement failure. Aging can also reduce pavement durability in terms of resistance to moisture and wear. The durability of asphalt binder is based at least in part on interaction among the chemical components within the asphalt binder and the capability of the asphalt binder to resist oxidation.

Changes in the relative quantities of the saturate, aromatic, resin, and asphaltene (SARA) fractions of asphalt binder show how its chemical composition changes during oxidative aging. The ratio of polar components (such as asphaltenes) to nonpolar components is higher in oxidized asphalt binder. Oxidative aging is believed to cause further molecular agglomeration of asphaltene components due to increasing aromatization of reactive compounds in the asphalt binder and the introduction of new polar functional groups on components of the asphalt binder. Thus, increases in both the asphaltene content and the asphaltene agglomerates are significant characteristics of oxidized asphalt binder. Changes in the arrangement of an asphalt binder's components during aging are reflected in changes in its physicochemical and rheological properties, giving rise to deterioration of the pavement's mechanical properties and performance.

### SUMMARY

The disclosure relates to the use of oils rich in phenolic compounds to improve the durability and increase the useful lifetime of asphalt binder. The phenolic family of compounds is a group of antioxidants that terminate the radical chain propagation of oxidation through quenching free radicals. This antioxidant activity can facilitate the prevention of oxidative damage that occurs during the aging process in asphalt binder. Phenolic molecules trap bitumen's volatile compounds in asphalt, preventing their release to the atmosphere and delaying asphalt aging induced by the mass loss of those compounds.

Bio-oils derived from wood-based bio-sources were introduced to asphalt binder to yield bio-modified asphalt binder, samples of which were then exposed to thermal aging. A chemical aging index and a rheological aging index were measured using Fourier transform infrared spectroscopy and a dynamic shear rheometer, respectively. Results showed that all phenol-rich bio-oils reduced the extent of aging in bio-modified asphalt binder. Computational modeling showed that the efficacy of each bio-oil is also affected by the molecular structures of its phenolic compounds; electron-donor substituents attached to the phenolic moiety promote the antioxidant activity of phenolic compounds.

A bio-modified asphalt binder includes an asphalt binder and a phenol-rich oil. The phenol-rich oil includes phenolic compounds. The phenol-rich oil typically includes about 5 wt % to about 75 wt % phenolic compounds (e.g., about 5 wt % to about 60 wt %, about 10 wt % to about 60 wt %, about 25 wt % to about 60 wt %, about 50 wt % to about 60 wt %, or about 50 wt % to about 55 wt %). In some cases, the phenol-rich oil is a bio-oil derived from biomass, such as pine bark, walnut shells, peanut shells, coconut husks, birch, fir, or any combination thereof. In some cases, a phenol-rich oil is combined with a bio-oil that is not naturally phenol-rich. The bio-modified asphalt binder typically includes about 5 wt % to about 15 wt % of the phenol-rich oil.

The phenolic compounds can include phenol, methylphenol, dimethylphenol, o-guaiacol, p-methylguaiacol, p-vinylguaiacol, trans-p-propenylguaiacol, p-allylguaiacol, syringol, vaniline, catechol, 3-methyl-1,2-benzenediol, 4-methyl-1,2-benzenediol, or a combination thereof.

In some cases, the phenol-rich oil includes phenol in a range of about 1 wt % to about 9 wt %, methylphenol in a range of about 0.5 wt % to about 2 wt %, dimethylphenol in a range of about 0.1 wt % to about 2 wt %, o-guaiacol in a range of about 0.5 wt % to about 5 wt %, p-methylguaiacol in a range of about 0.1 wt % to about 5 wt %, p-vinylguaiacol in a range of about 0.5 wt % to about 2 wt %, trans-p-propenylguaiacol in a range of about 0.1 wt % to about 4 wt %, p-allylguaiacol in a range of about 0.01 wt % to about 2 wt %, less than about 2 wt % syringol, less than about 4 wt % vaniline, catechol in a range of about 0.1 wt % to about 7 wt %, less than about 3 wt % 3-methyl-1,2-benzenediol, less than about 11 wt % 4-methyl-1,2-benzenediol, or any combination thereof.

The bio-modified asphalt binder can be used in building materials. In some implementations, a bio-modified asphalt includes the bio-modified asphalt binder and an aggregate material, such as rock, sand, gravel, slags, or any combination thereof. The bio-modified asphalt can also be used in building materials, such as pavement, roads, and roofing materials.

Advantages of bio-modified asphalt binder described herein include increased durability and decreased long term oxidative damage compared with unmodified asphalt binder. Pavement including the bio-modified asphalt binder can require fewer repairs and less frequent replacement, thereby reducing maintenance costs. Because it is produced from renewable plant-based sources rather than non-renewable petroleum-based sources, the bio-oil is environmentally friendly.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows molecular structures of representatives of three categories of phenolic compounds in bio-oils from different plant-based sources.

FIG. 2 shows a comparison of the bond dissociation enthalpy values (BDEs) for the phenolic compounds.

FIG. 3 shows the relative concentration of three categories of phenolic compounds in the bio-oils of Table 13.

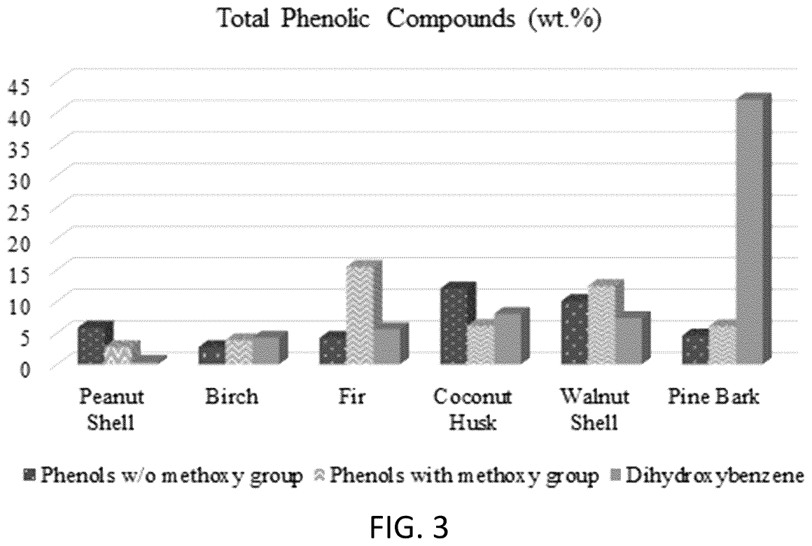

### DETAILED DESCRIPTION

This disclosure describes bio-modified asphalt binder made by combining bio-oils with asphalt binder. The bio-oils include phenolic compounds. The phenolic compounds can act as antioxidants by reacting with free radicals that are generated in the asphalt binder during aging processes. The antioxidant activity of the phenolic compounds included in bio-oils can facilitate the prevention of oxidative damage and thus increase the useful lifetime of bio-modified asphalt binder compared to unmodified asphalt binder.

The bio-oils can be produced from plants. Plants including lignin or lignified elements yield bio-oils with phenolic compounds. Bio-oils can be produced from woody biomass. Suitable plants or plant products that can produce bio-oils including phenolic compounds include pine bark, walnut shell, peanut shell, coconut husk, birch, and fir. Bio-modified asphalt binder can be used in the production of pavement, roads, and roofing materials.

A bio-modified asphalt binder includes an asphalt binder and a phenol-rich oil. The phenol-rich oil includes phenolic compounds. The phenol-rich oil typically includes about 5 wt % to about 75 wt % phenolic compounds (e.g., about 5 wt % to about 60 wt %, about 10 wt % to about 60 wt %, about 25 wt % to about 60 wt %, about 50 wt % to about 60 wt %, or about 50 wt % to about 55 wt %). In some cases, the phenol-rich oil is a bio-oil derived from biomass, such as pine bark, walnut shells, peanut shells, coconut husks, birch, fir, or any combination thereof. In some cases, a phenol-rich oil is combined with a bio-oil that is not naturally phenol-rich. The bio-modified asphalt binder typically includes about 5 wt % to about 15 wt % of the phenol-rich oil.

The phenolic compounds can include phenol, methylphenol, dimethylphenol, o-guaiacol, p-methylguaiacol, p-vinylguaiacol, trans-p-propenylguaiacol, p-allylguaiacol, syringol, vaniline, catechol, 3-methyl-1,2-benzenediol, 4-methyl-1,2-benzenediol, or a combination thereof.

In some cases, the phenol-rich oil includes phenol in a range of about 1 wt % to about 9 wt %, methylphenol in a range of about 0.5 wt % to about 2 wt %, dimethylphenol in a range of about 0.1 wt % to about 2 wt %, o-guaiacol in a range of about 0.5 wt % to about 5 wt %, p-methylguaiacol in a range of about 0.1 wt % to about 5 wt %, p-vinylguaiacol in a range of about 0.5 wt % to about 2 wt %, trans-p-propenylguaiacol in a range of about 0.1 wt % to about 4 wt %, p-allylguaiacol in a range of about 0.01 wt % to about 2 wt %, less than about 2 wt % syringol, less than about 4 wt % vaniline, catechol in a range of about 0.1 wt % to about 7 wt %, less than about 3 wt % 3-methyl-1,2-benzenediol, less than about 11 wt % 4-methyl-1,2-benzenediol, or any combination thereof.

The bio-modified asphalt binder can be used in building materials. In some implementations, a bio-modified asphalt includes the bio-modified asphalt binder and an aggregate material, such as rock, sand, gravel, slags, or any combination thereof. The bio-modified asphalt can also be used in building materials, such as pavement, roads, and roofing materials.

This disclosure describes the effects of phenol-rich bio-oils made from plant-based resources on the performance and durability of bio-modified asphalt binder against oxidative aging, by examining the extent of change in the physicochemical and rheological properties of bio-modified binder samples. The durability comparison is performed after simulating long-term oxidative aging on bio-modified specimens. A pressure aging vessel (PAV) is used to simulate long-term oxidative aging during the in-service life of binder, where hardening is controlled by chemical reactions between environmental oxygen and the binder. The binder's resistance to oxidative aging is related to the structure and antioxidant activity of the predominant phenolic compounds in the plant-based bio-oils, using quantum-level calculations via density functional theory analysis.

The efficacy of applying bio-modifiers in bituminous composites to reduce the emission of organic compounds from asphalt-surfaced areas when exposed to UV irradiation is described. Quantum-based molecular modeling and laboratory experiments were conducted to evaluate the capability of each bio-modifier to limit the volatilization of small bitumen molecules to suppress the asphalt mass loss and to delay asphalt aging. Phenol-rich bio-modifiers were found to behave as sorbents to retain oxygenated compounds in bitumen. This was shown by higher binding energies for the interaction of phenolic components in wood-pellets bio-modifier (WP) with bitumen's oxygenated compounds, ranging from −25.88 to −91.61 KJ/mol, compared to the range from −16.28 to −54.93 KJ/mol for the corresponding energy values resulting from interaction between the dominant components of waste vegetable oil (WVO) and bitumen's oxygenated compounds.

The presence of aryl groups and hydroxyl groups in the molecular structure of phenolic compounds increases their capability to adsorb oxygenated organic compounds in bitumen through considerable hydrogen bonding interactions. The thermodynamic stability of interacting complexes between WP phenolic molecules and small oxygenated compounds in bitumen leads to hindering molecular loss from bitumen, preventing the discharge of trapped VOCs to the atmosphere, and increasing bitumen's durability under UV irradiation.

The electronic character (electronic withdrawing or electron donating), the position, and the number of substituents attached to the phenolic ring was found to influence the electron distribution over a phenolic compound and consequently impact the strength of interaction with an oxygenated compound in bitumen. Electron-donating substituents increase the electron density in the aryl ring of a phenolic structure and subsequently increase the electron density in the interacting path between the phenol and an oxygenated compound. This electron delocalization increases the strength of hydrogen bonding and increases the thermodynamic stability of the interacting complexes formed.

Laboratory experiments showed that bitumen samples modified with WVO bio-modifier or WP bio-modifier had a lower extent of aging compared to that of neat bitumen and rubberized bitumen. There was a greater reduction in the case of WP-modified bitumen compared to WVO-modified bitumen. After 200 h of UV exposure, bio-modified rubberized bitumen containing wood pellet bio-oil (WP-BMR) showed a 47.7% lower increase in the complex modulus and a 40.4% lower increase in rutting indicator in comparison with WVO-BMR. In addition, WP-modified samples showed 21.9% and 11.7% greater reductions in the crossover modulus and crossover frequency, respectively.

The observed differences in the extent of aging between bitumen with WP bio-modifier and bitumen with WVO bio-modifier show that the anti-aging and VOC retention role of a bio-modifier significantly depends on its molecular composition, which is source-dependent. The effectiveness of WP bio-oil can be attributed to the phenolic compounds that are dominant in WP bio-oil, a bio-modifier extracted from a lignin-rich biomass.

Thus, modifying bitumen with a phenol-rich bio-modifier can increase the retention of volatile organic compounds in the bitumen matrix. Hindering the loss of volatiles from bitumen during its service life can improve the durability and aging resistance of bituminous composites while reducing emissions that decrease air quality.

### EXAMPLES

### Example 1

This example evaluates the capability of phenol-rich bio-oils to improve the durability of asphalt roads by hindering oxidative aging in asphalt binder. To do so, bio-oils derived from six wood-based bio-sources were introduced to asphalt binder; each specimen was then exposed to thermal aging. A chemical aging index and a rheological aging index were measured using Fourier transform infrared spectroscopy and a dynamic shear rheometer, respectively. All phenol-rich bio-oils reduced the extent of aging in bio-modified binder, however, the bio-oils' efficacy against aging varied, partly based on the content of their phenolic compounds. Computational modeling showed that the efficacy of each bio-oil is also affected by the molecular structures of its phenolic compounds; electron-donor substituents attached to the phenolic moiety promote the antioxidant activity of phenolic compounds. Phenol-rich bio-oils are shown to enhance durability of asphalt binder, while promoting carbon-negative built environments.

PG64-22 with the properties reported in Table 1 was used as the asphalt binder. The plant-based bio-oils were produced using pyrolysis by researchers at the University of Seoul in Seoul, South Korea. The bio-oils were from six plant sources: pine bark (PB), walnut shell (WS), peanut shell (PS), coconut husk (CH), birch (BR), and fir (FR). To prepare bio-modified binder samples, 10% of each bio-oil by weight of binder was mixed with neat binder at 135° C. for 30 min using a benchtop shear mixer at a speed of 750 rpm.

TABLE 1
Properties of PG64-22 asphalt binder

| Property | Value | |
|---|---|---|
| Specific Gravity (at 15.6° C.) | 1.041 | |
| Change in Mass (after RTFO) | −0.013% | |
| Flash Point (Cleveland open cup method) | 335° | C. |
| Absolute Viscosity (at 60° C.) | 179 | Pa · s |
| Stiffness (at −12° C., 60 s) | 71.67 | MPa |

Wood-based bio-oil is a complex material including polar light-weight compounds that are mostly phenolic compounds. The physical and chemical properties of the bio-oil are dependent on its molecular composition, which is greatly affected by the biomass type. Gas chromatography-mass spectroscopy (GC-MS) was used to determine the main differences between bio-oils made using different woody biomasses. Phenolic compounds may act as antioxidants by scavenging radicals produced during oxidative aging of asphalt binder. In terms of mass loss at 200° C., it was found that Fir bio-oil had the lowest mass loss of 38.2%, followed by BR (45.6%), PB (61.2%), WS (65.8%), PS (77.8%), and CH (86.9%). The overall density of the bio-oils was from 0.99-1.24 g/cm³.

Each bio-oil was characterized using a Gas Chromatography-Mass Spectrometer (GC-MS) to determine its chemical and molecular composition. Each sample was dissolved in dichloromethane (DCM) and was filtered before injection into the GC column. To separate molecules based on molecular weight, the GC-MS (7890A and 5975C, Agilent Instruments) was equipped with an HP-5MS (30 m 250 mm 0.25 μm) column. Helium as the carrier gas was maintained at 1 ml/min throughout the analysis. The samples were diluted 10-fold before 1 μl was injected into the column in split-less mode. The oven temperature was programmed as follows: hold 25° C. for 10 min, ramp up at 2° C./min to 150° C., ramp up at 20° C./min to 250° C., and isothermal for 10 min. The chromatogram and the major peaks were processed and integrated using ChemStation software and matched to the NIST17 database.

To simulate the aging process, bio-modified binder was aged by a two-step aging process: short-term aging followed by long-term aging. For short-term aging, specimens were subjected to aging in a rolling thin-film oven (RTFO) at 163ºC and 4 L/min airflow for 85 min, following ASTM D2872. To simulate long-term aging, the RFTO-aged samples were then exposed to a pressure aging vessel (PAV), following ASTM D6521. In this procedure, 50 g of RFTO-aged binder was aged in a PAV at an air pressure of 2.10 MPa at 105° C. for 20h.

A Bruker IFS 66V/S Vacuum FT-IR spectrometer was used to characterize the functional groups and determine the effect of oxidative aging on the chemical structure of bio-modified binder. The background spectrum was collected after cleaning the FTIR diamond crystal surface with isopropanol, and then subtracted from the sample spectrum. Wavenumbers ranging from 400 cm⁻¹ to 4000 cm⁻¹ were collected, at 4 cm⁻¹ resolution of 32 scans. Origin-Pro2021 software was used to calculate the peak areas in the spectrum of each sample corresponding to the presence of carbonyl groups. The carbonyl index was calculated as a ratio of the carbonyl peak area to the total area of the absorbance of the fingerprint region between 600-4000 cm⁻¹, as shown in Equation 1, to quantify the extent of change.

$$Carbonyl Index = \frac{Area under curve from 1680 - 1800 {cm}^{- 1}}{Area under curve from 600 - 4000 {cm}^{- 1}} \qquad ( 1 )$$

To facilitate comparing the extent of aging in modified binders by different phenol-rich bio-oils, the aging index (AI) for all physicochemical properties measured by chemical fingerprints and rheological measurements was calculated using the aging index equation (Equation 2). The ideal aging index value is zero, indicating no change in binder properties due to aging.

$$Aging Index = \frac{\vert aged value - unaged value \vert}{unaged value} \times 100 \qquad ( 2 )$$

An Anton Paar Modular Compact Rheometer MCR 302 was used to determine the elastic and viscous properties of the aged and unaged bio-modified binder samples, following the ASTMD7175 standard. The viscosity of each sample at a near-zero shear rate was measured at 50, 60, and 70° C. using the dynamic shear rheometer with an 8-mm spindle and a 2-mm sample gap. The results for zero-shear viscosity were used to determine the activation energy of the unaged and aged samples based on the linear model between temperature and viscosity shown in Equation 3 for each binder sample. Then, the activation-energy-based aging index was calculated using activation-energy values (Equation 2).

$$ln η = ln A + \frac{{E}_{a}}{R} \frac{1}{T} \qquad ( 3 )$$

where:
η=viscosity of binder (Pa·s)
Eₐ=flow activation energy (KJ·mol⁻¹)
R=universal gas constant (8.314×10⁻³ KJ·mol⁻¹. K⁻¹)
T=temperature (kelvin)
A=pre-exponential factor

All molecular-level calculations were performed using a density functional theory (DFT) approach embedded in the Gaussian 16 program package. All geometries were fully optimized using Becke's three-parameter hybrid exchange functional and the Lee-Yang-Parr′ correlation functional (B3LYP) as the functional, in conjunction with a 6-31 G(d) basis set. The spin-unrestricted B3LYP/6-31 G(d) method was used for the models of free radicals in the calculations of bond dissociation enthalpy. Vibrational frequencies were performed at the same level of theory to confirm that the optimized structures are local minima with no imaginary frequency. The effect of the molecular structure of a phenolic compound on its capability as an antioxidant was investigated by calculating the bond dissociation enthalpy (BDE) as a chemical descriptor. Here, the values of bond dissociation enthalpy for the phenolic compounds were determined in the gas phase through a hydrogen transfer mechanism. A DFT procedure is generally reliable to predict the effect of substituents on O—H BDE. The enthalpy value for the hydrogen atom in the gas phase at the same level of theory is 312.4 kcal/mol. BDE is defined as the enthalpy difference between a phenolic compound (ArOH) and its phenoxyl radical (ArO•) after hydrogen (H.) is transferred to the peroxyl or other free radicals through the gas-phase reaction (Equation 4).

$$B D E = {H}_{Ar 0 \cdot } + {H}_{H \cdot } - {H}_{ArOH} \qquad ( 4 )$$

where H_{ArO}., H_{H}., and H_{ArOH} are the enthalpy values for a phenoxyl radical, a hydrogen atom, and a phenolic compound, respectively. Ar is an abbreviation meaning “aromatic ring”.

The aging mechanism involves not only oxidation but also chain scission, aromatization, carbonation, and agglomeration of asphaltene molecules. The extent of oxidation is tracked based on the amount of increase in carbon-oxygen bonds formed as a result of aging.

Activation energy is used as an indicator of the effect of aging on rheology because it is sensitive to aging-induced agglomeration. Three replicates were tested, and the average of the three results was reported for an aging index based on the carbonyl index (Table 2) and an aging index based on activation energy (Table 3).

TABLE 2
Aging Index based on the Carbonyl Index, for neat and
bio-modified binders after oxidative aging (PAV).

| Bio-modified Binder | Aging Index - |
|---|---|
| by | Carbonyl Index (%) |
| CH oil | 146.2 |
| PB oil | 23.0 |
| BR oil | 11.6 |
| PS oil | 215.4 |
| WS oil | 31.7 |
| FR oil | 56.0 |
| Neat asphalt binder | 384.3 |

TABLE 3
Aging index based on activation energy for PAV-aged samples.

| Bio-modified Binder | Aging Index - |
|---|---|
| by | Activation Energy |
| PS oil | 5.4 |
| CH oil | 6.3 |
| FR oil | 4.8 |
| WS oil | 1.6 |
| PB oil | 5.8 |
| BR oil | 3.6 |
| Neat asphalt binder | 9.7 |

Understanding the changes that occur in the chemical functional groups of bio-modified binder after oxidative aging is advantageous to predict bio-oils' performance to delay aging. Therefore, the effects of long-term oxidative aging (PAV aging) on the chemical functional groups of each sample of bio-modified binder were monitored using FTIR, and the carbonyl index (C═O) was quantified for each bio-modified binder using Equation 1. The carbonyl index shows that all neat binder samples and bio-modified binder samples experienced increases in their carbonyl index after PAV aging, with the largest increase happening for the neat binder. To facilitate comparing the aging rate of studied scenarios, the aging index for C═O was calculated based on Equation 2, and the results are presented in Table 2. This table shows that all binder samples modified by phenol-rich bio-oils have lower values of aging index compared to the neat binder, meaning phenol-rich bio-oils decrease damage due to long-term aging and inhibit increases in carbonyl functional groups. This observation is in line with other studies which showed presence of wood-based bio-oils in asphalt binder reduces the rate of formation of carbonyl functional groups during asphalt binder aging. Formation of carbonyl groups is implicated in physical and rheological changes that occur during asphalt binder aging. Increase of carbonyl content gives rise to agglomeration of asphalt molecules. Among the considered bio-oils from plant-based biomass, birch (BR) bio-oil had the lowest aging index and peanut shell (PS) bio-oil had the highest. The explanation for these different performances in delaying aging can be that the antioxidant potency of phenolic compounds depends on their molecular and electronic structures, which are directly related to the source of the bio-oil.

Activation energy can be used as a measure of change in the interactions occurring between binder molecules and is associated with the thermal susceptibility of binder; higher values of activation energy indicate increased aging. To evaluate the resistance to oxidative aging of bio-modified binders, the values of the aging index based on activation energy (Equation 2) are reported in Table 3. As shown in this table, all binders modified by phenol-rich bio-oils showed a lower aging rate compared to the neat binder sample.

Oxidation promotes agglomeration in asphalt, but some bio-oil molecules are known to promote solubility and effectively de-agglomerate asphalt molecules. The effectiveness of a bio-oil modifier to improve resistance to oxidative aging can depend on its chemical composition. The molecular species in bio-oils can act according to their molecular structures and functional groups through two possible mechanisms; first, inhibiting the formation of polar fragments during oxidative aging due to their antioxidant capability, which is what phenolic compounds do; second, moderating the agglomeration induced by increased intermolecular interactions due to oxidation. Therefore, the ranking based on activation energy accounts for a bio-oil's effect on both oxidation and agglomeration, while carbonyl formation only accounts for oxidation. In other words, the efficacy of a bio-oil as an antioxidant can be evaluated by the carbonyl index, while a bio-oil's anti-aging effect can be evaluated by the activation energy. Therefore, the data indicate that BR bio-oil is effective antioxidant, and the WS bio-oil is an effective anti-aging agent.

Two unpaired electrons found in the electronic structures of oxygen make it a reactive oxidizing agent. The oxidation mechanism in the binder is initiated by hydrogen abstraction from the most reactive site of binder fragments, “benzylic carbons”, to form a free radical on the carbon. The reaction between a benzylic radical and atmospheric oxygen forms a peroxyl radical, and then hydroperoxide. Hydroperoxide is thermally unstable and can decompose to form free radicals or react through several routes, resulting in the formation of new polar functionalities such as carbonyl and sulfoxide or increasing the aromaticity and planarity in binder fragments. Phenolic compounds are antioxidants that can trap free radicals, so phenolic antioxidants can quench peroxyl radicals and terminate the reaction sequence in binder oxidation.

The molecular aspects of bio-modified binder were studied using density functional theory (DFT) calculations performed on the models of phenolic compounds. Using the DFT approach to simulate electronic properties is advantageous to explain quantitatively and qualitatively the reactivity parameters for phenolic species in different bio-oils. The chemical reactivity of the phenol-rich bio-oils and their effectiveness to delay oxidative aging was studied. The bio-oils disclosed here are rich in the phenolic compounds synthesized from molecular fragments extracted from plant-based biomass with a high content of lignin and the lignified elements.

The phenolic family is a major group of antioxidants that terminate the radical chain propagation of oxidation through quenching free radicals. The radical-scavenging activity of phenolic compounds can be characterized by a hydrogen-transfer (HT) mechanism in which O—H bond dissociation will occur. Hydrogen abstraction from an O—H group of a phenolic compound results in the formation of a phenoxyl radical (ArO•) that is more stable than the radicals formed during oxidative aging, including peroxyl radicals (ROO•). This stability can be explained using the resonance effect that occurs in the phenoxyl radical. The phenoxyl radical can react with a peroxyl radical in different ways that lead to non-radical products. The plant-based bio-oils used in this study have a considerable content of phenolic compounds that show promising potential as antioxidants for asphalt pavement. In the following sections, a series of phenolic compounds have been modeled and studied for their hydrogen-transfer capability, to examine the antioxidant efficacy of phenol-rich bio-oils at preventing the propagation of oxidation and thereby delaying aging in an asphalt mixture. Phenolic compounds can deactivate peroxyl radicals through hydrogen transfer and mitigate the oxidative aging in binder.

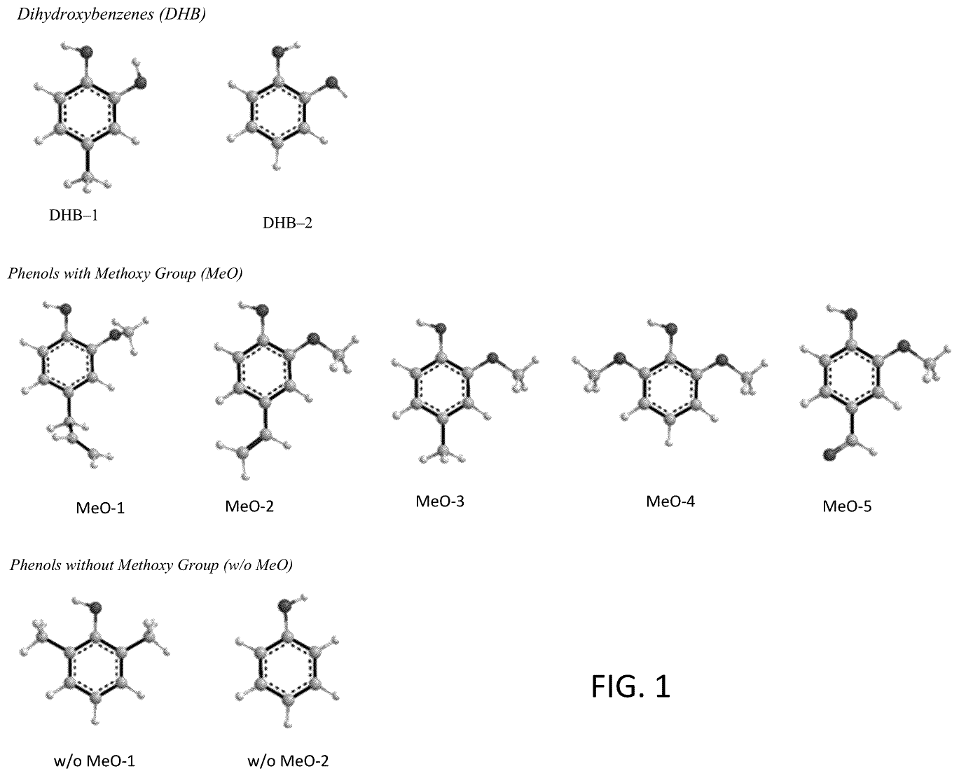

Based on the GC-MS peak-area percentages of the molecular fragments detected by mass spectrometry, the bio-oils produced from the six plant-based sources are complex mixtures of various compounds in which phenolic compounds make a prominent contribution. As the phenolic content of bio-oils in Table 4 shows, hydroxyl (O—H) and methoxy (O—Me) substituents are the main functional groups affecting the reactivity of phenols as antioxidants. The amount of lignin-type functional groups such as methoxy, hydroxyl, carboxyl, and carbonyl groups significantly varies depending on the composition of the bio-source. In this respect, the phenolic compounds in Table 4 are reported in three categories: phenols without a methoxy group, phenols with a methoxy group, and dihydroxybenzenes; these are respectively abbreviated as w/o MeO, MeO, and DHB. Based on the results, the bio-oils from the pyrolysis of pine bark (PB) and peanut shell (PS) have the highest and lowest concentration of phenols, respectively. Dihydroxybenzenes make a notable contribution to the total peak percentage for the bio-oils extracted from birch (BR) and pine bark (PB). Phenols with a methoxy group are the most abundant phenolic constituents compared to the other types of phenols in walnut shell (WS) and fir (FR) oil. The content of phenols without a methoxy group in the bio-oils from coconut husk (CH) and peanut shell (PS) is higher than the MeO and DHB concentrations. Therefore, it is expected that the efficacy of these bio-oils at delaying long-term oxidative aging will be controlled by the dominant type of phenolic compounds in each. For this reason, the antioxidant activity of phenols from the three categories (w/o MeO, MeO, and DHB) was used to interpret the different behavior of plant-based bio-oils at improving binder's durability and increasing its resistance against oxidative aging. In this respect, representative phenolic molecules were considered here to examine their electronic properties and their parameters for antioxidant reactivity. The molecular structures of phenolic compounds and their configurations are shown in FIG. 1.

TABLE 4
The main individual phenolic compounds of
plant-based bio-oils identified by GC-MS.

| | | | | Wal- | Pea- | Coco- |
|---|---|---|---|---|---|---|
| | | Pine | | nut | nut | nut |
| Compounds (wt. %) | Fir | Bark | Birch | Shell | Shell | Husk |
| Phenols without | | | | | | |
| Methoxy Group (w/o MeO) | | | | | | |
| Phenol | 1.84 | 2.25 | 1.83 | 6.02 | 2.69 | 8.64 |
| Methylphenol | 0.74 | 1.24 | 0.75 | 1.62 | 1.40 | 1.98 |
| Dimethylphenol | 1.28 | 0.81 | 0.16 | 0.28 | 0.55 | 0.63 |
| Other phenols | 0.32 | 0.27 | — | 2.11 | 1.18 | 0.76 |
| | 4.18 | 4.57 | 2.75 | 10.03 | 5.82 | 12.01 |
| Phenols with Methoxy | | | | | | |
| Group (MeO) | | | | | | |
| o-guaiacol | 4.50 | 0.68 | 0.63 | 2.13 | 0.64 | 1.14 |
| p-methylguaiacol | 4.06 | 0.30 | 0.53 | 0.11 | 1.01 | 0.42 |
| p-vinylguaiacol | 0.77 | 1.16 | 0.42 | 1.15 | 0.24 | 1.88 |
| trans-p-propenylguaiacol | 3.52 | 1.29 | 0.04 | 0.80 | 0.15 | 0.11 |
| p-allylguaiacol | 1.10 | 0.35 | 0.46 | 1.13 | 0.03 | 0.47 |
| Syringol | — | — | 1.09 | 0.86 | 0.03 | 1.01 |
| Vaniline | — | — | 0.42 | 3.65 | 0.22 | 0.36 |
| Other methoxy phenols | 1.48 | 2.27 | 0.25 | 2.60 | 0.43 | 0.71 |
| | 15.43 | 6.05 | 3.84 | 12.43 | 2.75 | 6.10 |
| Dihydroxybenzene (DHB) | | | | | | |
| Catechol | 2.81 | 30.90 | 0.74 | 4.73 | 0.38 | 6.99 |
| 3-methyl-1,2-benzenediol | — | 0.33 | 2.99 | 2.62 | — | 0.11 |
| 4-methyl-1,2-benzenediol | 2.75 | 10.79 | 0.49 | — | — | 0.90 |
| | 5.56 | 42.03 | 4.22 | 7.35 | 0.38 | 8.01 |
| Total Phenolic | 25.17 | 52.65 | 10.81 | 29.81 | 8.95 | 26.12 |
| compounds (wt. %) | | | | | | |

Nine phenolic compounds (w/o MeO (2), MeO (5), and DHB (2)) were investigated by quantum-based computational methods to elucidate the relationships between their molecular structures and their antioxidant activity. Thermodynamic and electronic parameters to describe their radical-scavenging reactivity were calculated at B3LYP/6-31G (d) level of theory. Further, the effects of substituents such as phenolic hydroxyl (O—H), methoxy (O—CH₃), carbonyl (C═O), and unsaturated hydrocarbon chain (—C═C) groups on the antioxidant activity of phenolic compounds and the electronic mechanisms of these effects were investigated. To determine the reactivity of phenolic compounds to delay oxidative aging in binder, their hydrogen-donating capability through a hydrogen-transfer (HT) mechanism was evaluated.

A HT mechanism is a one-step reaction related to the O—H bond dissociation enthalpy (BDE) (Equation 5). BDE is a numerical descriptor that is associated with the stability of an O—H bond, describing the hydrogen-donation capability of phenolic compounds and the formation of a stable phenoxyl radical. Phenoxyl radicals are important intermediates in relation to the antioxidant activity of phenols. Indeed, there is a correlation between the HT capability of phenolic compounds and the production of phenoxyl radicals to quench more free radicals generated during oxidative aging. A lower BDE value characterizes higher hydrogen-donating tendency and better free-radical scavenging.

$$ArOH + ROO \cdot \to Ar O \cdot + R OOH \qquad ( 5 )$$

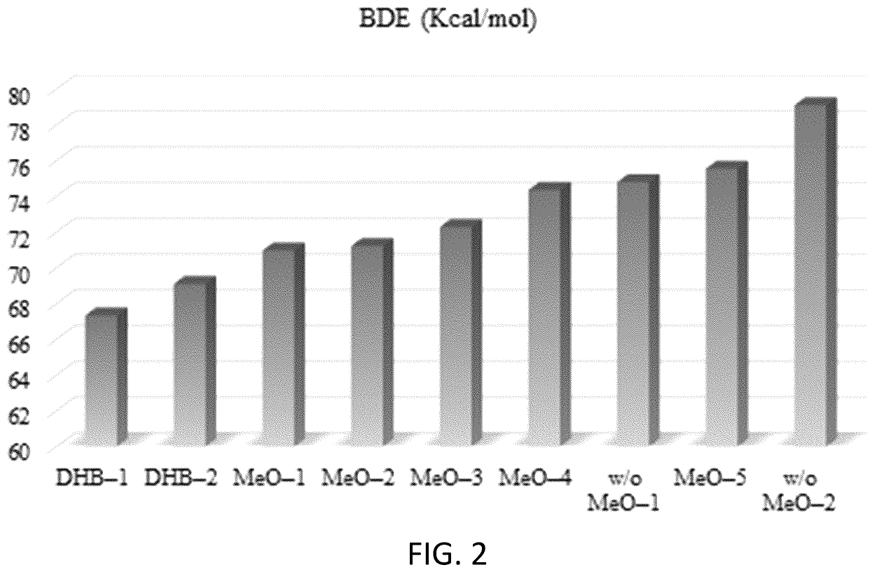

The calculated O—H BDE values for the identified phenolic compounds are reported in Table 5. In parallel, the BDE values for the nine phenolic representatives available in plant-based bio-oils have been plotted in FIG. 2 to provide insight into the ranking in antioxidant activity of phenolic compounds in the six bio-oils. As clearly shown, dihydroxybenzenes have the highest hydrogen-donating capability (the lowest BDE values) and phenols without a methoxy group have the lowest hydrogen-donating capability (the highest BDE values). This means that the capability for antioxidant activity of the three different types of phenolic compounds is as follows: dihydroxybenzenes (DHBs)>phenols with methoxy group (MeOs)>phenols without methoxy group (w/o MeOs).

BDE values are governed by the stability of a phenolic compound and the stability of a phenoxyl radical. The electronic effects that influence the stability of a phenolic compound and its phenoxyl radical mainly include the conjugation effect, the induction effect, and spin delocalization of the unpaired electron. Phenol (w/o MeO-2) is in the list of representative molecules as a common segment and antioxidant-activity center in all phenolic compounds, to evaluate the effect of substituents on the BDE values. Based on the BDE values reported in Table 5, the introduction of the phenolic hydroxyl group (OH) and the methoxy group (OCH₃) reduces the OH BDE of phenolic compounds, which corresponds to lower stability of OH and higher antioxidant activity. Compared to w/o MeO-1 and w/o MeO-2, the BDE values of DHBs and MeOs decrease, and the BDEs of DHB-1 and DHB-2 are the lowest values in this table. The hydroxyl group (O—H) is more effective in comparison with the methoxy group (O—Me) to enhance the antioxidant activity of phenolic compounds. The BDE of DHB-1 is 5.0 kcal/mol lower than that of MeO—3. The only difference between the molecular structures of DHB-1 and MeO—3 is replacement of the OH group in DHB-1 by an OCH₃ group leading MeO—3. The hydroxyl group is an electron donor group, and a phenoxyl radical produced in the HT mechanism has an oxygen atom carrying an unpaired electron; thus, the hydroxyl group can form an intramolecular hydrogen bond with the oxygen and stabilize it. This electronic behavior of a hydroxyl group enhances the antioxidant activity of the other O—H in a phenolic compound. Although the methoxy group improves the antioxidant activity of phenolic compounds, the presence of a carbonyl group (C═O) in MeO—5 increases the stability of the corresponding O—H bond and its BDE value (75.6 kcal/mol), indicating that the OH bond is not easily broken. MeO—5 has the highest BDE value among the other molecules from the category of phenolics with a methoxy group. This may be related to the induction effect: —C═O is considered to be an electron withdrawing group that increases the O—H bond dissociation energy of MeO—5, which is about 3.3 kcal/mol higher than that of MeO—3 and about 4.7 kcal/mol higher than that of MeO—1. The BDE value is also influenced by the overall hydrocarbon framework of the phenolic compound and the conjugation and delocalization of an unpaired electron after hydrogen transfer, which can directly reflect the hydrogen-donation capability of a phenolic compound. The unsaturated substituents, —CH₂—CH═CH₂ and —CH═CH₂, in MeO—1 and MeO—2 reduce the BDE value of phenolic compounds with a methoxy group by about 3.0 kcal/mol on average, which indicates that —CH₂—CH═CH₂ and —CH═CH₂ significantly favor a conjugation and resonance effect on the para oxygen-center radical.

TABLE 5
The calculated bond dissociation enthalpies,
BDEs (kcal/mol), for nine tested phenolic compounds
in gas phase at B3LYP/6-31 (d) level.

| Phenolic compounds | Abbreviation | Formula | BDE (kcal/mol) |
|---|---|---|---|
| 4-methyl-1,2-benzenediol | DHB-1 | C₇H₈O₂ | 67.3 |
| Catechol | DHB-2 | C₆H₆O₂ | 69.1 |
| p-allylguaiacol | MeO-1 | C₁₀H₁₂O₂ | 70.9 |
| p-vinylguaiacol | MeO-2 | C₉H₁₀O₂ | 71.2 |
| p-methylguaiacol | MeO-3 | C₈H₁₀O₂ | 72.3 |
| Syringol | MeO-4 | C₈H₁₀O₃ | 74.4 |
| Dimethylphenol | w/o MeO-1 | C₈H₁₀O | 74.8 |
| Vaniline | MeO-5 | C₈H₈O₃ | 75.6 |
| phenol | w/o MeO-2 | C₆H₆O | 79.1 |

Results for the aging index based on the carbonyl index of bio-modified binders (Table 2) show that there is a relationship between the effectiveness of bio-oils to delay aging and their phenolic content. In general, phenol-rich bio-oils show high efficacy to delay oxidative aging. A lower carbonyl-based aging index for binder modified by phenol-rich bio-oil compared to the corresponding value for neat asphalt binder is evidence to support this hypothesis. However, it appears that the electronic structure of the dominant type of phenolic compounds in each bio-oil and the relative concentration of different types of phenolic compounds are more important factors in determining the antioxidant effectiveness of a bio-oil. The effectiveness of bio-oils from birch (BR) and pine bark (PB) in delaying binder oxidative aging may be related to the presence of phenolic compounds with two hydroxyl groups (dihydroxybenzenes) as the dominant type in their chemical composition. Oils from the pyrolysis of fir (FR) and walnut shell (WS) show good performance in increasing the resistance of binder against factors responsible for oxidative aging, due to their high content of phenols with methoxy groups compared to the other two phenolic types.

This example confirms that the life of asphalt roads can be extended by using phenol-rich high-carbon bio-oils. Using experiments and computational techniques. First, the efficacy of six bio-oils made from plant-based biomasses was shown to delay long-term oxidative aging in bio-modified asphalt binders; second, the durability of a bio-modified binder was shown to be related to the molecular composition of the bio-oil and its electronic nature. The antioxidant capacity of a bio-oil is mainly attributed to the presence of molecular fragments that have the capability to scavenge the free radicals generated during oxidative aging. The effects of oxidative aging on the rheological and physicochemical properties of asphalt binders containing each of six plant-based bio-oils is summarized below.

According to FTIR analysis, each aged bio-modified binder showed a lower carbonyl aging index compared to aged neat binder as a control sample. This observation is attributed to the presence of phenolic compounds in high concentrations in bio-oils extracted from lignin-rich biomass. Phenolic compounds have a role as scavengers to quench free radicals generated during oxidative aging; this antioxidant activity in turn delays the aging progress. In terms of the carbonyl aging index, BR-modified binder and PB-modified binder performed better than the other samples.

Electronic analysis using DFT-based computational modeling confirmed the source dependence of aging resistance and the relationship between a bio-oil's performance and its molecular composition. It was found that a bio-oil's effectiveness to delay long-term oxidative aging is based on having a high content of the phenolic compounds that are most suited to scavenging free radicals.

Electronic analysis also explained the differences in the effectiveness of phenol-rich bio-oils to delay oxidative aging by showing the relationship between the molecular structure of phenolic compounds and their antioxidant activity. In a bio-oil, the molecular structure of the dominant phenolic compounds and their substituents can directly reflect the hydrogen-donation capability of the phenolic compounds to quench free radicals. For example, molecular substituents that can form intramolecular hydrogen bonding compensate for electron deficiency, and increased electron delocalization in the phenoxyl radicals can enhance the scavenging activity of phenolic compounds. Thus, ortho-methoxy groups, hydroxyl groups, and a double bond in the side chain attached to the phenolic moiety all increase scavenger activity.

The aging index based on activation energy for bio-modified asphalt binder is lower than the corresponding value for the neat asphalt binder. Activation energy is affected by oxidation and agglomeration in the aging mechanism. Therefore, phenol-rich bio-oils are effective at delaying the overall aging of asphalt binder by hindering both oxidation and agglomeration.

### Example 2

This example demonstrates the capability of bio-modifiers to retain oxygenated compounds in bitumen and thereby extend the bitumen's durability. It is believed that phenolic compounds of bio-modifiers enhance intermolecular interactions with oxygenated compounds that would otherwise be released to the atmosphere as bitumen ages. Computational modeling based on density functional theory (DFT) confirms the capability of phenolic compounds in bio-oil from wood pellets (WP) as a modifier for bitumen to interact with bitumen's volatile oxygenated compounds through strong hydrogen bonding. DFT-based energy results show that the efficacy of a phenolic molecule to trap bitumen's oxygenated compounds is influenced by its molecular structure and substituents attached to the phenolic moiety; electron donor groups such as —CH₃ and —OCH₃ can enhance the scavenging activity of phenolic compounds. Molecular modeling also shows that the interacting complexes formed between bitumen's oxygenated compounds and WP's phenolic components are more thermodynamically favored than complexes formed by these volatiles and non-phenolic molecules in waste vegetable oil (WVO). Laboratory experiments confirm the delay in UV aging of bio-modified rubberized bitumen containing wood pellet bio-oil (WP-BMR) by showing lower values for aging indexes based on rheological properties (crossover modulus and frequency, the complex modulus, activation energy, and a rutting indicator) compared to the rubberized bitumen containing low-phenol WVO bio-modifier (WVO-BMR). Therefore, the extent of aging varies between two bio-modified bitumen samples depending on the bio-modifier's source and chemical composition. The durability of asphalt can be improved by tuning bitumen's aging resistance using phenol-rich bio-modifiers made from lignin-based biomass.

Effective applications of phenol-rich bio-modifier can be used to increase asphalt's aging resistance and durability, providing both environmental and economic advantages. Phenol-rich bio-modifier derived from wood pellets may be used to decrease bitumen's mass loss by retention of organic volatiles within a bituminous mixture, delaying the bitumen's aging. Because of the features of their molecular structure, phenolic compounds are capable of forming stable interacting complexes with bitumen's lightweight compounds, to keep these volatiles in the bitumen matrix. Molecular modeling in the framework of density functional theory has been used in combination with measurements from laboratory experiments using rheological tests and

FTIR analysis. Electronic analysis and molecular modeling evaluate the possibility of intermolecular interactions between phenolic molecules in bio-modifier and small oxygenated compounds in bitumen. Binding energy could be a good parameter to determine stability of the formed interacting complexes, leading to more trapping of bitumen's volatiles. The accuracy of computational evaluation is supported by defining aging indexes based on rheological and chemical metrics, then comparing experimentally obtained aging indexes for bio-modified bitumen with those for unmodified bitumen.

The neat bitumen was performance grade PG 64-22 (indicating highest pavement service temperature 64° C. and lowest −22° C.); Table 6 shows its basic properties. Crumb rubber was produced from scrap tires made from synthetic rubber and natural rubber; the crumb rubber included 23.5% carbon black and had particle size smaller than 40 mesh. One bio-modifier was derived from wood pellets (WP); the other was derived from waste vegetable oil (WVO). Their basic properties are presented in Table 7. Solvent separation was used to separate each modified asphalt binder into four generic fractions. Certain compounds in bio-modifiers that are insoluble in n-heptane are categorized as asphaltenes, even though there are chemical and molecular differences between compounds named asphaltenes. To compare the effect of the bio-modifiers, neat bitumen and crumb-rubber-modified bitumen (CRM) were also investigated.

TABLE 6
Basic properties of neat bitumen PG 64-22

| Properties | Values | | Testing methods |
|---|---|---|---|
| Specific gravity @15.6° C. | 1.041 | | ASTM D70 |
| Penetration @25° C. | 70 (0.1 mm) | | ASTM D5 |
| Softening point | 46.0° | C. | ASTM D36 |
| Ductility @ 15° C. | >100 | cm | ASTM D113 |
| Cleveland open cup method flash point | 335° | C. | ASTM D92 |
| Mass change after rolling thin-film oven | −0.013% | | ASTM D6 |
| Absolute viscosity @ 60° C. | 179 | Pa · s | ASTM D2171 |
| Stiffness @−12° C., 60 s | 85.8 | MPa | ASTM D6648 |

TABLE 7
Basic properties of bio-oil from wood pellets
(WP) and bio-oil from waste vegetable oil (WVO)

| | | Properties | WP | WVO |
|---|---|---|---|---|
| Density (g/cm³) | | | 1.230 | 0.898 |
| Shear modulus @50° C., 10 Hz (Pa) | | | 923.6 | 26.8 |
| | Elements (%) | Carbon | 61.05 | 77.30 |
| | | Hydrogen | 6.93 | 12.08 |
| | | Oxygen | 31.81 | 10.50 |
| | | Nitrogen | 0.21 | 0.12 |
| | Components* (%) | Saturates | 3.46 | 0.00 |
| | | Aromatics | 2.93 | 87.19 |
| | | Resins | 76.21 | 12.80 |
| | | Asphaltenes | 17.38 | 0.00 |

*Thin-layer chromatography with flame ionization detection (TLC-FID) was used for the SARA fractions analysis.

Bio-modified rubberized bitumen (BMR) was prepared by mixing 15% bio-modifier and 15% crumb rubber into PG 64-22 by weight of base binder. A high-shear mixer at 3000 rpm for 30 min at 180±5° C. was used for shearing and blending. Two types of bio-modifiers, WP and WVO, were used to prepare BMR specimens in this study; the specimens are respectively named as WP-BMR and WVO-BMR.

Samples of WP-BMR and WVO-BMR were UV aged by using an accelerated weathering tester (UVA 0.71 W/m2/nm @340 nm) to simulate the UV irradiation of sunlight. To prepare a uniform thin film of a sample for UV aging, the preheated sample was spread over a silicon rubber pan with a diameter of 75 mm, then the pan was placed in an oven at 140° C. for 20 min. The average thickness of each specimen was ˜0.7 mm. All specimens were placed in the UV chamber under continuous exposure at 60° C. for periods of 50, 100, and 200 h.

A dynamic shear rheometer was used to measure the elastic and viscous properties of neat, rubberized, and bio-modified rubberized bitumen samples, following ASTM D7175 standard test methods. An oscillation test was conducted at 52° C. using a parallel-plate setup with 8-mm diameter and 2-mm thickness, at a strain rate of 0.1% and a frequency range of 0.1-100 rad/s. The complex modulus (G*) and phase angle (δ) were calculated for all specimens using Equation 6. The crossover values can be used to measure the extent of aging in a binder sample. The crossover modulus (G_{c}) and crossover frequency (ƒ_{c}) were determined by measuring the modulus and frequency at 10° C. and a phase angle of 45 degrees.

UV aging affects the polarity and molecular composition of bitumen, influencing the intermolecular interactions within the bitumen matrix and leading to variations in the activation energy of bitumen. The viscosity of each sample was quantified at temperatures of 50, 60, and 70° C. by flow sweep. Measured viscosities were applied to calculate the activation energy (Eₐ) using Equation 7.

$${G}^{*} = \frac{{τ}_{ma x}}{{γ}_{ma x}} \qquad ( 6 )$$

$$in which {τ}_{max} = \frac{2 T}{π {r}^{3}} and {γ}_{ma x} = ( \frac{θ r}{h} )$$

γₘₐₓ=maximum strain
τₘₐₓ=maximum stress
T=maximum applied torque
R=radius of the sample
θ=deflection (rotational) angle
h=height of the sample

$$ln η = ln A + \frac{{E}_{a}}{RT} \qquad ( 7 )$$

where:
η is the bitumen viscosity (Pa·s) at temperature T (K)
Eₐ is the activation energy (J·mol⁻¹)
R is the universal gas constant (8.314 J· mol⁻¹. K⁻¹)
A is the pre-exponential factor

To evaluate the extent of oxidative aging and the effect of UV irradiation on the molecular composition of neat and bio-modified binders, there is a need to characterize the functional groups. To do this, an FTIR spectrometer with diamond ATR was used to determine the changes in the functional groups of bitumen samples that resulted from UV aging. Acetone was applied to clean the diamond crystal surface before testing; the background spectrum was collected first and subtracted from a tested sample's spectrum. Wavenumbers ranging from 400 cm⁻¹ to 4800 cm⁻¹ were collected with a scan frequency of 32 times/min at a resolution of 4 cm⁻¹ in a vacuum environment.

Free radicals generated by UV exposure can boost the formation of carbonyl groups by attacking unsaturated groups, resulting in oxidized products such as ketones and carboxylic acids. To determine the aging propensity of each type of bitumen sample (neat, rubberized, or bio-modified), the peaks of stretching vibration of carbonyl groups in the FTIR spectra at 1740 cm⁻¹ were determined. For the quantitative analysis of these functional groups, the spectra were first normalized with aliphatic peaks, then the peak absorbance areas were measured. The bond index of the carbonyl group for the bitumen sample was calculated using Equation 8.

$$Carbonyl Index = \frac{Area under curve from 1680 ‐ 1800 {cm}^{- 1}}{Area under curve from 600 ‐ 4000 {cm}^{- 1}} \times 100 \qquad ( 8 )$$

To evaluate the capability of phenolic components to retain volatile oxygenated compounds in bitumen, the interactions of phenolic components with target oxygenated compounds were modeled using a quantum mechanical approach in the framework of density functional theory (DFT), available in the Gaussian 16 package. All molecular structures and interacting complexes were optimized using M05-2X as a hybrid meta exchange-correlation functional and 6-31+G* as basis set. Computations were followed by harmonic vibrational frequency calculations at the same level of theory, to confirm stationary points as transition minima on their potential energy surfaces.

The binding energies (ΔE), as a measure of the thermodynamic stability of interacting complexes, were computed as a difference between the total energy of the complex and the sum of the energies of the isolated monomers (Equation 9).

$$Δ E = {E}_{complex} - \sum {E}_{isolated monomers} \qquad ( 9 )$$

Further electronic analysis was used to gain insight into the influence of the molecular structure of phenolic compounds (as predominant molecules in the WP bio-modifier) on the possible mechanisms involved in the retention of oxygenated compounds in bio-modified bitumen (BMR). The nucleus-independent chemical shift (NICS) index was used to measure aromaticity in the aryl group of different phenolic compounds. In addition, quantum theory of atoms in molecules (QTAIM) analysis was performed on all optimized complexes by using the AIM2000 program to calculate the electron density, ρ(r), at the bond critical points of interactions between phenols and oxygenated compounds. All required wave functions were generated at the M05-2X/6-31+G* level.

The objective of DFT energy calculations is to model the strength of interaction between the components of the WP bio-modifier and the oxygenated compounds in bitumen. This part of the computations was conducted to address two themes: how phenolic compounds in the WP bio-modifier retain volatile organic molecules in the bitumen; and whether certain phenols are better than other phenols at trapping volatile organic molecules. Phenol is a strong hydrogen-bond donor, and hydrogen bonding is a common feature of molecular reactivity. So, the activity of phenolic compounds to trap bitumen's oxygenated compounds is related to their ability to form hydrogen bonding with the functional group of oxygenated compounds. The presence of a hydroxyl group in the molecular structure of a phenolic compound is known as an active center involved in the intermolecular hydrogen-bonding interactions. The bitumen volatiles for these DFT calculations consisted of eight oxygenated compounds selected from molecules detected in asphalt-related emissions. The formation of hydrogen-bonded complexes between each of nine WP phenolic compounds with different structural substituents and each of eight oxygenated compounds in bitumen was investigated. The better interaction of oxygenated compounds with WP phenolic compounds could be rationalized through stronger hydrogen-bonding interactions. The strength of interactions in a complex of WP and an oxygenated compound was calculated in terms of the binding energies, ΔE. As reported in Table 3, ΔE values are in the range of −25.88 to −91.61 KJ/mol. A higher O—H binding energy means a greater tendency for the phenol to interact with oxygenated compounds, which translates to better scavenging activity and better anti-aging efficacy.

According to the data given in Table 8, the highest ΔE is calculated for interacting complexes involving the WP phenolic compound with OCH₃ and CH₃ substituents, and the lowest ΔE is calculated for those formed by the interaction of the WP phenol without substituents (X=H in Table 8). Comparing all energy values reported in Table 3 with the corresponding values for the unsubstituted phenol complexes, all phenolic substituents enhance the strength of hydrogen bonding with oxygenated compounds in bitumen and consequently increase the magnitude of the binding energies (values that are more negative). The trend observed for the effectiveness of phenolic substituents to increase the reactivity of a phenolic compound to interact with oxygenated compounds in bitumen is as follows (listed from strongest to weakest): OCH₃, CH₃>OCH₃, C₂H₃>OCH₃, OCH₃>OCH₃, CHO>CH₃, CH₃>OCH₃, C₃H₅>CH₃, OH>OH>H. Therefore, the electronic nature of the substituents attached to a phenolic compound is a key factor that determines the strength of hydrogen-bonding interactions and the phenolic's ability to trap oxygenated organic compounds in bitumen. The electron-donating substituents act as activating groups for the phenolic moiety (Aryl-OH) and increase the T-electron cloud in the WP phenol ring, improving the charge transfer from the phenol ring to its oxygen atom. This electronic behavior could increase the proton-accepting characteristic of phenol, leading to more favorable hydrogen bonding with an oxygenated compound and a more stable interacting complex. As the substituents become more electron-donating in complexes of WP and an oxygenated compound, the binding energies become higher (Table 8).

However, the other decisive factors in the observed trend for the effectiveness of substituents are factors such as having spatial hinderance, having a hydrogen-bond-accepting nature, having an electron-withdrawing characteristic, and having unsaturated bonds. For example, O—CH₃ has a hydrogen-bond-accepting nature, so the phenolic hydroxyl (O—H) might be involved in intramolecular hydrogen bonding; thus, the strength of intermolecular hydrogen bonding is decreased. The presence of CH═CH₂ (C₂H₃) in the para position with respect to the phenolic hydroxyl significantly favors a conjugation and resonance effect, consequently affecting the stabilization of the interacting complex. An electron-withdrawing group such as CHO deactivates the phenolic ring and thereby decreases the corresponding binding energies.

TABLE 8
Calculated binding energies (in kJ · mol⁻¹) for complexes of WP and
an oxygenated compound in bitumen. X represents the substituents.

| WP Phenolic | Oxygenated Compounds | | | | | | | |
|---|---|---|---|---|---|---|---|---|
| Compounds | C₁₀H₂₂O | C₁₀H₂₀O | C₁₀H₁₈O | C₁₀H₁₆O | C₁₀H₁₄O | C₁₀H₁₂O | C₁₀H₁₀O | C₁₀H₈O |
| X = H | −25.88 | −34.29 | −36.43 | −42.72 | −43.01 | −43.29 | −47.69 | −50.14 |
| X = CH₃, CH₃ | −34.23 | −49.99 | −53.31 | −51.21 | −51.92 | −53.71 | −69.92 | −73.26 |
| X = OCH₃, CH₃ | −49.73 | −68.30 | −71.49 | −79.28 | −83.48 | −84.85 | −88.35 | −91.61 |
| X = OCH₃, C₂H₃ | −49.19 | −67.36 | −70.45 | −78.30 | −78.80 | −75.34 | −79.72 | −79.88 |
| X = OCH₃, C₃H₅ | −27.88 | −47.14 | −50.28 | −52.17 | −52.20 | −63.22 | −69.01 | −72.56 |
| X = CH₃, OH | −27.82 | −46.88 | −49.40 | −52.08 | −65.90 | −66.86 | −66.32 | −72.40 |
| X = OCH₃, CHO | −41.80 | −48.84 | −56.75 | −54.16 | −47.72 | −64.36 | −72.45 | −74.58 |
| X = OCH₃, OCH₃ | −41.90 | −49.30 | −61.84 | −63.98 | −68.84 | −72.46 | −74.92 | −75.19 |
| X = OH | −27.38 | −46.22 | −48.25 | −49.04 | −48.58 | −46.31 | −55.02 | −71.76 |

To verify the efficacy of WP bio-modifier molecules with a phenolic nature to trap bitumen's oxygenated compounds, the energy results listed in Table 8 were compared with the corresponding values for the interaction of waste vegetable oil (WVO) molecules with the same oxygenated compounds. The calculated binding energies resulting from interaction between the dominant WVO components and oxygenated compounds at the same level of theory range from −16.28 to −54.93 KJ/mol. This comparison showed that complexes of WP and an oxygenated compound are more thermodynamically favorable than the complexes of WVO and the oxygenated compound, due to the effective structural features of WP components. Overall, DFT-based energy evaluation of the interaction strength of WP and WVO toward some oxygenated compounds of bitumen shows that the WP phenolic compounds perform better at retaining the volatiles in the bitumen matrix and delaying their emission. This result is of particular importance because it indicates that the prevailing forces in the —O—H— intermolecular hydrogen-bond interaction originate not only from the electrostatic forces but also from the structural effects.

To further examine the strength of interactions in the interacting complexes, electron density analysis in the intermolecular region was performed using the framework of AIM theory. Based on AIM theory, a bond path is a trajectory of maximally concentrated electron density (p) connecting a pair of bonded atoms, and bond critical points (BCPs) are electron-density extremes. Table 9 lists the electron density at bond critical points (PBCP) on the —O—H— interaction paths for the optimized complexes of WP and an oxygenated compound. Values of electron density were used for qualitative comparison of hydrogen-bond strength for all complexes; a small electron density at a bond critical point indicates a weak interaction between the WP phenolic component and the oxygenated compound. It is rational to say that the electronic characteristics of phenolic substituents influence the accumulation of electron density in the intermolecular region and consequently influence the stability of an oxygenated compound over a phenolic component. Based on the ρBCP values reported in Table 9, there is a direct relationship between the electron density at the bond critical point of —O—H— interactions and the electron-donating nature of substituents: more electron-donating characteristics lead to a higher PBCP value. It should be kept in mind that the addition of an electron-withdrawing group or even an electron-donating group that brings steric hindrance in the interaction region will reduce the effect of the electron-donating group to lead electron condensation between two interacting molecules. The calculated electron densities show that a phenolic compound with OCH₃ and CH₃ substituents shows the highest ρBCP in interaction with most of the oxygenated compounds considered in this study, and a phenol without substituent (X=H in Table 9) shows the lowest.

TABLE 9
Calculated electron densities (ρ in e/a₀³) at —O•••H—
BCP for complexes of WP and an oxygenated compound. X represents the substituents.

| WP Phenolic | Oxygenated Compounds | | | | | | | |
|---|---|---|---|---|---|---|---|---|
| Compounds | C₁₀H₂₂O | C₁₀H₂₀O | C₁₀H₁₈O | C₁₀H₁₆O | C₁₀H₁₄O | C₁₀H₁₂O | C₁₀H₁₀O | C₁₀H₈O |
| X = H | 1.864 | 2.451 | 2.511 | 2.611 | 2.751 | 2.864 | 2.931 | 3.124 |
| X = CH₃, CH₃ | 1.924 | 2.776 | 2.854 | 2.954 | 2.996 | 3.116 | 3.216 | 3.321 |
| X = OCH₃, CH₃ | 2.166 | 2.638 | 2.691 | 2.791 | 2.838 | 3.166 | 3.266 | 3.462 |
| X = OCH₃, C₂H₃ | 2.082 | 2.626 | 2.702 | 2.772 | 2.826 | 3.108 | 3.113 | 3.214 |
| X = OCH₃, C₃H₅ | 2.150 | 2.517 | 2.616 | 2.716 | 2.817 | 3.150 | 3.210 | 3.370 |
| X = CH₃, OH | 2.023 | 2.575 | 2.587 | 2.687 | 2.875 | 3.123 | 3.202 | 3.336 |
| X = OCH₃, CHO | 1.929 | 2.517 | 2.589 | 2.689 | 2.717 | 3.146 | 3.216 | 3.326 |
| X = OCH₃, OCH₃ | 2.155 | 2.383 | 2.757 | 2.757 | 2.983 | 3.155 | 3.135 | 3.367 |
| X = OH | 2.088 | 2.567 | 2.571 | 2.771 | 2.887 | 3.088 | 3.212 | 3.401 |

The trend observed for βBCP values is well correlated with that for binding energy (ΔE): ΔE increases as the electron density (βBCP) at the critical point of a hydrogen bond increases.

The aromaticity of the ring in the phenolic structure changes when the WP phenolic component is substituted with different groups and when it participates in hydrogen-bonding interactions with different oxygenated compounds. The NICS index was studied to identify the aromatic character of WP phenolic components in all considered complexes of WP and an oxygenated compound. The NICS values at 1.0 Å above the molecular plane, denoted as NICS(1), are reported in Table 10. The NICS results in Table 10 show that the electronic nature of phenolic substituents and the electronic nature of bound oxygenated compounds influence the electron delocalization throughout the interacting complex and consequently its stabilization. For example, electron-donating substituents attached to the phenolic compound increase its aromaticity and improve electron delocalization in the interacting complex, resulting in higher binding energy and a more stabilized complex. The main conclusion drawn from the NICS results is that, in addition to the substituents' electronic character (electronic withdrawing or electron donating), the position and the number of substituents attached to the phenolic ring alter its aromaticity. As clearly shown, the phenolic compound with OCH₃ and CH₃ substituents has the largest NICS(1) value; a more negative NICS value indicates a more aromatic ring. There is good agreement between the values for aromaticity and the values for binding energies (ΔE) (Table 8); an increase in ΔE corresponds to an increase in NICS.

TABLE 10
Calculated NICS(1) values of complexes of WP and an oxygenated compound. X represents the substituents.

| WP Phenolic | Oxygenated Compounds | | | | | | | |
|---|---|---|---|---|---|---|---|---|
| Compounds | C₁₀H₂₂O | C₁₀H₂₀O | C₁₀H₁₈O | C₁₀H₁₆O | C₁₀H₁₄O | C₁₀H₁₂O | C₁₀H₁₀O | C₁₀H₈O |
| X = H | −10.589 | −10.765 | −10.779 | −10.824 | −10.845 | −10.879 | −10.866 | −10.914 |
| X = CH₃, CH₃ | −10.692 | −10.792 | −10.794 | −10.801 | −10.832 | −10.853 | −10.912 | −10.956 |
| X = OCH₃, CH₃ | −11.647 | −11.877 | −11.898 | −11.971 | −12.013 | −12.090 | −12.133 | −12.229 |
| X = OCH₃, C₂H₃ | −10.929 | −11.554 | −11.737 | −11.950 | −11.888 | −11.895 | −11.827 | −11.994 |
| X = OCH₃, C₃H₅ | −10.742 | −10.800 | −10.869 | −10.875 | −10.865 | −10.895 | −10.920 | −10.912 |
| X = CH₃, OH | −10.621 | −10.784 | −10.764 | −10.898 | −10.910 | −10.994 | −10.991 | −11.213 |
| X = OCH₃, CHO | −11.145 | −11.192 | −11.405 | −11.293 | −11.269 | −11.554 | −11.650 | −11.644 |
| X = OCH₃, OCH₃ | −11.458 | −11.509 | −11.597 | −11.623 | −11.737 | −11.810 | −11.821 | −11.836 |
| X = OH | −11.378 | −11.562 | −11.569 | −11.610 | −11.631 | −11.682 | −11.801 | −11.972 |

To evaluate the extent of change in the properties of each bitumen sample after aging, aging indexes based on the metrics used in this section were calculated using Equation 10. The values for seven aging indexes are reported in Table 11.

$$AI = \vert \frac{aged value - unaged value}{unaged value} \vert \times 100 \% \qquad ( 10 )$$

The complex modulus (G*) and the phase angle (δ) of neat bitumen, crumb-rubber-modified bitumen, and the two types of bio-modified rubberized bitumen at 52° C. show a steady decrease in δ and a steady increase of G* for all bitumen samples as aging progressed, indicating the hardening of bitumen. The observed bitumen hardening could be associated with a loss of volatiles and with chemical changes such as aromatization and carbonation. Both the loss of volatiles and the chemical changes occur in bitumen throughout UV aging. Among the studied samples, the rubberized bitumen containing the WP bio-modifier showed the lowest change in G* (G*—based aging index) of 220.8% after UV exposure for 200 h, indicating better resistance to UV aging; neat bitumen showed the highest G*—based aging index of 345.3%, indicating the worst UV aging resistance (Table 11).

The G* graphs of all bitumens had the same pattern, while the δ graphs presented different shapes, such as a plateau or peak at the intermediate-frequency region, decreased 8 in the low-frequency region, or increased δ in the high-frequency region. The elastic networks formed by polymer cross-linking and polymer-bitumen entanglements in WP-BMR could explain the plateau zone in phase angles. The swelling of crumb-rubber particles in BMRs leads to a decreased δ at lower frequencies. Along with the aging, the decreased δ had a rise at low frequencies, due to the viscous response as a result of rubber devulcanization during aging. Based on the δ-based aging index, the UV-aging resistance of WVO-BMR (aging index 7.7%) was better than that of WP-BMR (aging index 8.6%) at 10 rad/s.

One of the indicators that measures the extent of UV aging in a bitumen binder is rutting resistance, defined as the ratio of the complex modulus to the sine of the phase angle (G*/sinδ) at 10 rad/s. Changes in the G*/sinδ values at 52° C. after UV aging for neat bitumen, crumb-rubber-modified bitumen, and the two types of bio-modified rubberized bitumen show overall increases in G*/sinδ as aging progressed, indicating hardening of bitumen throughout UV aging. The addition of crumb rubber to bitumen, CRM, results in the highest G*/sinδ values, while the WVO-BMR has the lowest G*/sinδ values. The aging rate at each period of UV exposure is also important; the aging rate is measured by dividing the change in G*/sinδ by the exposure time of each aging period (0−50 h, 50−100 h, and 100−200 h). Based on the calculation of aging rate, CRM has the highest aging rate at each UV aging period, and WVO-BMR has the lowest aging rate.

After 200 h aging, WP-BMR has the lowest aging index based on G*/sinδ (234.7%), showing the greatest resistance to UV aging, followed by CRM (241.6%), WVO—BMR (275.1%), and PG 64-22 with the highest aging index of 327.2%, indicating the least resistance to UV aging (Table 11). The UV-aging resistance of the bio-modified rubberized bitumens studied here, WVO-BMR and WP-BMR, is shown to depend on the source of the bio-modifier.

The effect of the two bio-modifiers on bitumen aging was studied using a frequency sweep test to assess the crossover points. The crossover point is defined by the crossover frequency, ƒ_{c}, and the crossover modulus, G_{c}*. G_{c}*, and ƒ_{c} can be correlated to a polymer's zero-shear viscosity (ZSV), molecular weight, and molecular distribution: higher values of ZSV, molecular weight, and polydispersity cause lower values of G_{c}*, and ƒ_{c}*. Therefore, G_{c}*, and ƒ_{c}* are reliable parameters to track aging. Increases in polarity during aging can intensify intermolecular interactions and agglomeration in aged bitumen; consequently, UV exposure increases the values of ZSV, molecular weight, and polydispersity, leading to decreases in G_{c}* and ƒ_{c}*. WVO-BMR exhibited the highest sensitivity to UV exposure, followed by PG 64-22. Table 11 shows the values for the aging index based on G_{c}* and ƒ_{c}*. It was found that WP-BMR had the lowest G_{c}*-based aging index (23.0%) and the lowest ƒ_{c}*-based aging index (81.8%), indicating that WP-BMR had the most resistance to UV aging. WVO-BMR had a higher G_{c}*-based aging index (44.9%) and a higher ƒ_{c}-based aging index (93.5%). The difference in performance between the WP and WVO bio-modifiers in response to UV aging could be attributed to their difference in chemical composition: the high concentration of phenolic compounds and other reactive components such as furfural in wood-pellet oil has been shown to delay thermal aging and UV aging.

The activation energy (Eₐ) of neat bitumen, crumb-rubber-modified bitumen, and the two bio-modified rubberized bitumens were compared after different UV exposure times. The increased polarity of aromatics and resins caused by aging makes the mentioned species insoluble enough to separate in heptane or to agglomerate to the original asphaltenes. These chemical changes result in an increase of the asphaltene content and a decrease of aromatics and resins in the aged bitumen. Oxidative aging mainly promotes intermolecular interactions and asphaltene agglomeration in bitumen, which affect the activation energy. Therefore, changes in the activation energy at each level of aging depend on the degree of agglomeration in the aged bitumen. For example, at a low aging time, nanoaggregates can easily shear against each other and may make a reduction in activation energy, explaining what is observed for CRM in 0−50 h UV aging period. As aging progresses, increasing molecular agglomerations due to aromatization and carbonation could increase the activation energy. After 200 h UV exposure, all bitumens' activation energy increased compared to the unaged samples. Since bio-modifiers have different effects on the oxidative aging and agglomerations, the degree of increase in activation energy is different for each bio-modified sample.

Table 11 reports the aging index based on activation energy for all bitumen samples. The results indicate that rubberized bitumen with WP, WP-BMR, has the lowest Eₐ-based aging index of 11.5%, showing the highest resistance to UV aging compared to the other bitumen samples. The lower Eₐ-based aging index for WP-BMR compared to that reported for WVO-BMR could be attributed to the presence of polar aromatics such as phenolic compounds in WP from the decomposition of lignin in the wood biomass. Phenolic compounds might effectively prevent oxidative aging and demote agglomeration during UV aging, causing a reduction in activation energy.

FTIR analysis was performed to track the chemical changes in bitumen samples after UV aging. The carbonyl group is one of the functional groups that rises as aging progresses. Table 6 shows that after 200 h UV exposure, bio-modified rubberized bitumen samples (BMRs) have lower values of the carbonyl-based aging index compared to neat bitumen and crumb-rubber-modified bitumen. Among the two BMRs, WVO-BMR has a lower carbonyl-based aging index (19.9%) compared to WP-BMR (56.8%). The difference between the two BMRs in chemical changes based on carbonyl functional groups is mainly attributed to the chemical composition of the bio-modifier used. Comparing the two bio-modifiers, WVO is based on vegetable oil containing unsaturated fatty acids; these can act as free-radical scavengers during UV aging, to protect bitumen fragments from oxidation and thereby prevent carbonyl-group formation. Unsaturated fatty acids are also able to absorb UV and could act as a protective shield against UV radiation. The wood-based bio-modifier, WP, has a high percentage of unsaturated compounds that are vulnerable to UV radiation and are further converted to ketones and carboxylic acids (carbonyl-containing groups) by reacting with UV-induced free radicals. These compounds could act as sacrificial compounds that are oxidized first, before fragments of the bitumen itself, thus protecting the bitumen against UV aging. Another distinction between the chemical compositions of the WP and WVO bio-modifiers is the higher concentration of phenolic compounds in the WP bio-modifier. The carbonyl results reinforce the hypothesis that the antioxidant activity of phenolic compounds through scavenging free radicals leads to phenoxyl radicals and ultimately quinone derivatives (containing carbonyl groups). Therefore, the formation of carbonyl groups could be higher in the bio-modified bitumen because it has a high content of phenolic compounds. These series of carbonyl groups could not intensify agglomerations in aged bitumen and could not result in performance deterioration of asphalt; this is evident from WP-BMR's lower values for the aging index based on activation energy (Table 11).

To evaluate the extent of UV aging from different perspectives, Table 11 summarizes for each bitumen the aging indexes based on different properties. The last column in this table shows the bitumen that has the most resistance against UV aging, based on that metric; that column shows that bio-modified bitumens are the best candidates to use against UV aging. WP-BMR appears more than WVO-BMR in the last column, indicating modifying rubberized bitumen with WP bio-modifier results in a higher capability to delay UV aging.

TABLE 11
Aging indexes based on studied indicators for neat bitumen
(PG 64-22), crumb-rubber-modified bitumen (CRM), and
two bio-modified rubberized bitumens (WP-BMR and WVO-
BMR) after 200 h UV exposure. A lower value of an aging
index indicates better resistance to aging.

| | | | | | | The bitumen |
|---|---|---|---|---|---|---|
| | | PG | | | | most resis- |
| | | 64- | | WP- | WVO- | tant to |
| Bitumens | | 22 | CRM | BMR | BMR | UV aging |
| Aging | G* @ 52° C., 10 | 345.3 | 280.0 | 220.8 | 268.5 | WP-BMR |
| indexes | δ @ 52° C., | 12.9 | 16.1 | 8.6 | 7.7 | WVO-BMR |
| based | 10 rad/s | | | | | |
| on (%) | G*/sinδ @ | 327.2 | 241.6 | 234.7 | 275.1 | WP-BMR |
| | 52° C. | | | | | |
| | G_{c}* @ 10° C. | 45.0 | 36.0 | 23.0 | 44.9 | WP-BMR |
| | ƒ_{c} @ 10° C. | 93.5 | 96.6 | 81.8 | 93.5 | WP-BMR |
| | Eₐ | 13.6 | 14.4 | 11.5 | 12.9 | WP-BMR |
| | I_{C} = 0 | 114.4 | 70.2 | 56.8 | 19.9 | WVO-BMR |

This example demonstrates that phenol-rich bio-modifiers can be used as sorbents to retain oxygenated compounds in bitumen. This was shown by higher binding energies for the interaction of phenolic components in wood-pellets bio-modifier (WP) with bitumen's oxygenated compounds, ranging from −25.88 to −91.61 KJ/mol, compared to the range from −16.28 to −54.93 KJ/mol for the corresponding energy values resulting from interaction between the dominant components of waste vegetable oil (WVO) and bitumen's oxygenated compounds.

The presence of aryl groups and hydroxyl groups in the molecular structure of phenolic compounds increases their capability to adsorb oxygenated organic compounds in bitumen through considerable hydrogen bonding interactions. The thermodynamic stability of interacting complexes between WP phenolic molecules and small oxygenated compounds in bitumen leads to hindering molecular loss from bitumen, preventing the discharge of trapped VOCs to the atmosphere, and increasing bitumen's durability under UV irradiation.

The electronic character (electronic withdrawing or electron donating), the position, and the number of substituents attached to the phenolic ring influence the electron distribution over a phenolic compound and consequently impact the strength of interaction with an oxygenated compound in bitumen. Electron-donating substituents increase the electron density in the aryl ring of a phenolic structure and subsequently increase the electron density in the interacting path between the phenol and an oxygenated compound. This electron delocalization increases the strength of hydrogen bonding and increases the thermodynamic stability of the interacting complexes formed.

Laboratory experiments showed that bitumen samples modified with WVO bio-modifier or WP bio-modifier had a lower extent of aging compared to that of neat bitumen and rubberized bitumen. There was a greater reduction in the case of WP-modified bitumen compared to WVO-modified bitumen. After 200 h of UV exposure, WP-BMR showed a 47.7% lower increase in the complex modulus and a 40.4% lower increase in rutting indicator in comparison with WVO-BMR. In addition, WP-modified samples showed 21.9% and 11.7% greater reductions in the crossover modulus and crossover frequency, respectively.

The observed differences in the extent of aging between bitumen with WP bio-modifier and bitumen with WVO bio-modifier show that the anti-aging and VOC retention role of a bio-modifier significantly depends on its molecular composition, which is source-dependent. The effectiveness of WP bio-oil is attributed to the phenolic compounds that are dominant in WP bio-oil, a bio-modifier extracted from a lignin-rich biomass.

Thus, modifying bitumen with a phenol-rich bio-modifier can increase the retention of volatile organic compounds in the bitumen matrix. Hindering the loss of volatiles from bitumen during its service life can improve the durability and aging resistance of bituminous composites while reducing emissions that decrease air quality.

### Example 3

This example shows the effect of phenol-rich bio-oils made from woody biomass to improve the durability of asphalt binder as measured by its resistance to thermal and ultraviolet (UV) aging. Various bio-oils rich in phenols were added to asphalt binder; each specimen was exposed to thermal and UV aging independently for 20 hours. Rheometry was used to track the progress of aging in each sample. All binders containing bio-oils generally showed greater resistance to aging regardless of the mode of aging. After 20 hours of UV aging, chemical aging indices were found to be up to 36% less for bitumen containing bio-oils compared to neat bitumen. Additionally, a computational chemistry procedure based on density functional theory was used to predict the antioxidant activity of phenol-rich bio-oils and further explain our experiment results for the resistance of the asphalt against long-term oxidative aging. A hydrogen transfer mechanism is one of the thermodynamically more favorable mechanisms to quench free radicals produced during oxidative aging. Bond dissociation enthalpy values were evaluated for hydrogen abstraction from phenolic compounds to determine hydrogen's reactivity to act as an antioxidant. Results showed that the hydrogen-donating capability of phenolic compounds is affected by the induction effect of substituents and spin delocalization of the unpaired electron of the resulted phenoxy radical. The phenolic hydroxyl (—OH) and methoxy (O—CH₃) groups can decrease the O—H bond dissociation enthalpy and promote antioxidant activities of phenolic compounds. The role of bio-oils in improving asphalt binder's resistance to aging was demonstrated.

A bio-oil containing a high concentration of phenolic compounds derived from lignin-rich wood was found to reduce rubber segregation in rubberized asphalt by 82%. The use of hindered phenols showed excellent aging resistance in terms of softening point and viscosity aging indices, resulting in reduced binder viscosity and reduced stiffening after aging that led to lower moisture damage, longer service life, and improved rutting and stripping resistance in asphalt mixtures containing co-polymers.

Three laboratory tests were used to simulate the aging of asphalt. The rolling thin-film oven (RTFO), which maintains an elevated temperature, was used to imitate short-term oxidative aging during binder production and placement, where increases in viscosity are largely controlled by dissipation of volatile compounds and oxidation. A pressure aging vessel (PAV), which maintains heat and pressure, was used to imitate long-term oxidative aging during in-service life of asphalt, where hardening is controlled by chemical reactions between environmental oxygen and the binder. A UV-aging chamber was used to simulate the effects of solar irradiation. In addition, computational modeling geared toward the use of density functional theory (DFT) was used to study the relationship between structure and antioxidant activity for the predominant phenolic compounds in the plant-based bio-oils.

Petroleum binder (PG 64-22) was supplied by HollyFrontier Corporation in Arizona (Table 12). The plant-based bio-oils were produced using pyrolysis by researchers at the University of Seoul in Seoul, South Korea. Bio-oils from six plant sources were tested: pine bark (PB), walnut shell (WS), peanut shell (PS), coconut husk (CH), birch (BR), and fir (FR). Each bio-oil was mixed with neat asphalt binder at 135° C. to obtain 10% bio-oil content by weight, based on other research in bitumen aging involving plant-based bio-oils.

TABLE 12
Properties of PG64-22 binder

| Property | Value | |
|---|---|---|
| Specific Gravity (at 15.6° C.) | 1.041 | |
| Change in Mass (after RTFO) | −0.013% | |
| Flash Point (Cleveland open cup method) | 335° | C. |
| Absolute Viscosity (at 60° C.) | 179 | Pa · s |
| Stiffness (at −12° C., 60 s) | 85.8 | MPa |

Oxidative aging of the binder was simulated using the RFTO and PAV. Unaged binder was first introduced into the RTFO and exposed to a temperature of 163° C. and an airflow of 4 L/min for 85 minutes. The RFTO-aged samples were then placed into the PAV where they were subjected to a temperature of 105° C. and pressure of 2.1 MPa for 20 hours.

The binder samples were exposed to ultraviolet aging to simulate the irradiation effects of sunlight on bitumen. Glass slides containing annealed bitumen samples were introduced into a QUV Accelerated Weather Tester. UV aging was performed for 20 hours at 65° C. and 0.71 W/m² irradiation intensity.

Changes in the chemical structure of aged binder were analyzed using a Bruker IFS 66V/S Vacuum FT-IR spectrometer. Origin-Pro2021 software was used to calculate the peak areas in the spectrum of each sample that correspond to the presence of carbonyl and sulfoxide groups, using verified integration approaches. The carbonyl index and sulfoxide index were calculated using Equation 11 to compare the chemical structure changes in aged binder, based on prior work.

$$Carbonyl Index = \frac{Area under curve from 1680 ‐ 1800 {cm}^{- 1}}{Area under curve from 600 ‐ 4000 {cm}^{- 1}} \times 100 \qquad ( 11 )$$

$$Sulfoxide Index = \frac{Area under curve from 960 ‐ 1050 {cm}^{- 1}}{Area under curve from 600 ‐ 4000 {cm}^{- 1}} \times 100 \%$$

An aging index (AI) to compare various aged parameter values relative to unaged values for each sample was calculated using the base aging index equation (Equation 12). The optimal aging index value is zero, indicating no change in the value of the aging parameter after aging.

$$Aging Index = \frac{\vert aged x value - unaged x value \vert}{unaged x value} \times 100 \% \qquad ( 12 )$$

Aging indices for the carbonyl and sulfoxide indices were calculated using Equation 12, where

$$x = \{ \begin{matrix}arbonyl index \\ sulfoxide index\end{matrix} \}$$

A modified aging index (Equation 13) was calculated to compare PAV-aged results to RTFO-aged results, due to the potential for certain aging indicators to display trends after short-term aging that are likely not due to aging mechanisms. Thus, comparing PAV-aged results to RTFO-aged results may be a more meaningful and realistic measure of a bio-oil's anti-aging efficacy.

$$Modified Aging Index = \frac{\vert PAV aged x value - RTFO aged x value \vert}{RTFO aged x value} \times 100 \% \qquad ( 13 )$$

Carbonyl and sulfoxide modified aging indices were calculated using Equation 13, where

$$x = \{ \begin{matrix}carbonyl index \\ sulfoxide index\end{matrix} \}$$

A chemical aging index that accounts for both the carbonyl index and the sulfoxide index was calculated using Equation 14, to provide a more succinct picture of the potential for carbonyl and sulfoxide reduction.

$$Chemical Aging Index = \frac{\vert aged ( carbonyl + sulfoxide ) index - unaged ( carbonyl + sulfoxide ) index \vert}{unaged ( carbonyl + sulfoxide ) index} \times 100 \% \qquad ( 14 )$$

Since the effects of UV aging occur mostly at the binder surface, increased care was taken to preserve the surface texture during UV-bound sample preparation, storage, aging, and FTIR testing. The FTIR testing was performed separately from that on thermally aged samples. Oxidatively aged specimens were taken from the middle section of stored samples to ensure adequate representation of the sample bulk.

Elastic and viscous properties of the binder samples before and after aging were determined using an Anton Paar MCR 302 dynamic shear rheometer. A frequency sweep (10-100 rad/s) at a strain rate of 0.1% was performed using an 8-mm spindle. The complex shear modulus was measured, which describes resistance to deformation of the binder sample under repeated shearing action. The crossover modulus is the complex modulus at a phase angle of 45°.

Aging indices and modified aging indices for crossover modulus and crossover frequency were calculated using Equation 12 and Equation 13, respectively, where

$$x = \{ \begin{matrix}crossover modulus \\ crossover frequency\end{matrix} \}$$

The viscosity of each sample at a near-zero shear rate was measured at 50, 60, and 70° C. using the dynamic shear rheometer with an 8-mm spindle and a 2-mm sample gap. The measurements were used to determine the activation energy based on the linear model between temperature and viscosity shown in Equation 15 for each binder sample.

$$ln η = ln A + \frac{{E}_{a}}{R} \frac{1}{T} \qquad ( 15 )$$

where:
η=viscosity of binder (Pa·s)
Eₐ=activation energy (KJ·mol⁻¹)
R=universal gas constant (8.314×10⁻³ KJ·mol⁻¹. K⁻¹)
T=temperature (kelvin)
A=pre-exponential factor
   An aging index and modified aging index were calculated for activation energy using Equation 12 and Equation 13, respectively, where

$$x = \{ activation energy \}$$

An adhesion test was performed to obtain a relative measure of the adhesive force between each bio-oil bitumen sample and glass before and after UV aging, as an indicator of the adhesion between bitumen and mineral aggregates in a pavement mixture. The test used a force meter to measure the pull-off force required to separate a bitumen sample from a glass bead that had been resting on the bitumen surface for 10 minutes.

An aging index for adhesion strength was calculated using Equation 12, where

$$x = \{ adhesion strength \}$$

Here, the bond dissociation enthalpy (BDE) values for the phenolic compounds were determined in the gas phase through a hydrogen transfer mechanism. A density functional theory (DFT) procedure is generally reliable to predict the effect of substituents on O—H BDE. For the modeling part, all calculations were performed using a density functional approach embedded in the Gaussian 16 program package. All geometries were fully optimized at B3LYP density functional, in conjunction with 6-31 G(d) basis set. Spin unrestricted B3LYP/6-31 G(d) method was used for the models of free radicals in the bond dissociation enthalpy calculations. Vibrational frequencies were performed at the same level of theory to confirm that the optimized structures are local minima with no imaginary frequency. The enthalpy value for the hydrogen atom in the gas phase at the same level of theory is 312.4 kcal/mol. BDE is defined as the enthalpy difference between a phenolic compound (ArOH) and its phenoxy radical (ArO•) after hydrogen (H.) is transferred to the peroxy free radical through the gas-phase reaction

$$\begin{matrix}( Equation 16 ) & \\ BDE = {H}_{ArO \cdot } + {H}_{H \cdot } - {H}_{ArOH} . & ( 16 )\end{matrix}$$

where H_{ArO}., H_{H}., and H_{ArOH} are the enthalpy values for a phenoxy radical, a hydrogen atom, and a phenolic compound, respectively.

Carbonyls and sulfoxides are two chemical functional groups that are known to increase in magnitude during aging and are commonly used as aging indicators. For the unaged condition, neat binder surpassed all bio-oil samples in terms of the carbonyl index. However, unaged PB had the lowest sulfoxide index, 41% less than the neat binder. Neat binder was dominant among RTFO-aged samples in terms of both the carbonyl and sulfoxide indices. For the long-term aged condition, the neat binder was again the most favorable in terms of the carbonyl index. However, PS had the lowest PAV-aged sulfoxide index, being 21% lower than that of the neat binder.

Aging indices for the carbonyl and sulfoxide indices for the thermally aged samples were calculated. The bio-oil samples were much more effective at inhibiting growth of the carbonyl function groups. RTFO-aged CH had a carbonyl-index aging index 90% lower than that of the RTFO-aged neat binder, while that for PAV-aged BR was 97% less than for the PAV-aged neat binder. For the sulfoxide-index aging index, WS was 99% more effective at limiting the emergence of sulfoxide functional groups than the neat binder for short-term aging, while FR was 94.1% more effective for long-term aging. It is likely that the decrease in the carbonyl index after short-term aging is not wholly due to oxidation but may also be the result of volatiles loss or carbonation during short-term aging. BR was 17% more effective and PS was 70% more effective at reducing carbonyl and sulfoxide content increases, respectively, compared to neat binder after PAV aging relative to RTFO aging. Based on the chemical index, WS showed the lowest value after PAV aging, 95% less than that of the neat binder.

The carbonyl and sulfoxide indices were also calculated for bio-oil samples before and after UV aging. The effects of UV exposure occur mostly at the surface of bitumen and are transferred by diffusion deeper into the bulk of the bitumen. CH showed the lowest carbonyl index before and after UV aging, being 20.5% and 25% less than the neat binder for the unaged and UV-aged condition, respectively. The neat binder had the lowest sulfoxide index among the unaged samples. For the UV-aged condition, CH had the lowest sulfoxide index, being 23.9% lower than that of the UV-aged neat binder. Resistance to UV aging has been shown to depend on the source of the bio-oil used in bitumen.

The aging indices for the carbonyl and sulfoxide indices for the UV-aged samples were compared. BR had the lowest carbonyl-index aging index among all UV-aged samples, being 51.1% more effective at preventing increases in carbonyl functional groups than neat binder. CH had the lowest sulfoxide-index aging index, outperforming the neat binder by 86.7%. The chemical aging index indicates CH as having the least evidence of chemical aging functional groups, 62% less than the neat binder.

Activation energy can be used as a measure of changes in the interactions occurring between bitumen molecules and is associated with the thermal susceptibility of bitumen; higher values indicate increased aging. The activation energy of the different bio-oil samples was compared. Among unaged samples, CH had the lowest activation energy (136.6 kJ), 3.6% better than the neat binder. The neat binder displayed the least evidence of aging in terms of activation energy (147.4 kJ) after short-term aging. FR displayed the lowest activation energy (138.6 kJ), 10.9% lower than the neat binder, after long-term aging. FR and BR had final aging activation energies that were lower than their respective unaged conditions by 4.8% and 3.7%, respectively.

Neat binder showed the smallest increase in activation energy (4%) relative to the unaged binder for short-term aging. However, for long-term aging, neat binder was least effective at minimizing activation energy increases. It was found that the aging indices for all bio-oil samples decreased with more aging but increased for the neat binder. PB was most effective, 34% more effective than the neat binder, at reducing the activation energy between RTFO to PAV aging.

The adhesion strength of asphalt bitumen is a property that affects the performance of asphalt pavement, since low adhesion could lead to debonding of bitumen from aggregate and subsequent pavement deterioration. For the unaged condition, all of the bio-oil samples showed a higher adhesion force than the neat binder, with WS showing the highest adhesion force at 3.59N, 147.6% greater than the adhesion force of the unaged neat sample binder. However, after UV-aging, the neat bitumen showed the highest adhesion force (0.38N) and lowest aging index, indicating superior effectiveness in limiting adhesion loss.

The crossover modulus has been related to various aging parameters such as oxygen uptake and changes in the carbonyl and sulfoxide content. Reduced crossover modulus and frequency values indicate stiffer, less compliant bitumen. For the crossover modulus, the neat binder outperformed the bio-oil samples for all aging conditions. For crossover frequency, bio-oil samples exceeded the neat binder samples by rather sizable margins for both the unaged and long-term aged conditions. Among unaged samples, BR exceeded the neat bitumen crossover frequency by 80.8%, while CH showed the highest crossover frequency for the long-term aging condition, being 40.8% greater than that of the neat PAV sample.

For short-term aging, PB had the lowest crosssover-modulus aging index. For long-term aging, the neat binder had the lowest crossover-modulus aging index. CH had the lowest crossover-frequency aging index for RTFO aging, while the neat binder had the lowest for PAV aging. PS showed a 67% better effectiveness relative to neat binder in increasing crosssover frequency for between RTFO and PAV aging.

Density functional theory (DFT) calculations were performed on the models for phenolic compounds. Using the DFT approach to simulate electronic properties is instrumental to explain quantitatively and qualitatively the reactivity parameters for phenolic species in different bio-oils. Here, the chemical reactivity of the phenol-rich bio-oils and their effectiveness to delay oxidative aging were compared. The tested bio-oils are rich in the phenolic compounds synthesized from molecular fragments extracted from plant-based biomass with high content of lignin and the lignified elements.

The phenolic family is a group of antioxidants that terminate the radical chain propagation of oxidation through quenching free radicals. The radical-scavenging activity of phenolic compounds can be characterized by a hydrogen-transfer (HT) mechanism in which O—H bond dissociation will occur. Hydrogen abstraction from an O—H group of a phenolic compound results in the formation of a phenoxy radical (ArO•), more stable than the radicals formed during oxidative aging, including peroxy radicals (ROO•). This stability can be explained using the resonance effect that occurs in the phenoxy radical. The phenoxy radical can react with another phenoxy radical in different ways that lead to non-radical products. Thus, bio-oils containing a high concentration of phenolic compounds can be used as antioxidants for an asphalt mixture.

The antioxidant efficacy of phenolic compounds sourced from plant-based bio-oils to prevent the propagation of oxidation in an asphalt mixture was assessed. It is believed that phenolic compounds can deactivate peroxy radicals through hydrogen transfer and mitigate the oxidative aging in asphalt.

The selected plant-based bio-oils used have a considerable content of phenolic compounds suitable for use as antioxidants for asphalt pavement. To investigate the effect of the phenolic content of bio-oils on their reactivity as asphalt antioxidants to delay oxidative aging, a series of phenolic compounds have been modeled and studied for their hydrogen-transferring ability.

Based on the GC-MS peak area percentage of the molecular fragments detected by mass spectrometry, the bio-oils produced from the six plant-based sources are a complex mixture of various compounds in which phenolic compounds make a prominent contribution in the chemical composition of the oils. As the phenolic content of plant-based bio-oils in Table 13 shows, hydroxyl (O—H) and methoxy (O—Me) substituents are the main functional groups affecting the reactivity of phenols as antioxidants. It is worth noting that the amount of lignin-type functional groups such as methoxy, hydroxyl, carboxyl, and carbonyl groups significantly varied depending on the bio-source composition. In this respect, phenolic compounds in Table 13 were reported in three categories; phenols without a methoxy group, phenols with a methoxy group, and dihydroxybenzenes, which are respectively abbreviated as w/o MeO, MeO, and DHB. Based on these results, the bio-oils from the pyrolysis of pine bark and peanut shell have the highest and lowest concentration of phenols, respectively. The phenolic composition of each bio-oil was compared in terms of the relative quantity of its three kinds of phenols: phenols without a methoxy group, phenols with a methoxy group, and dihydroxybenzenes. Dihydroxybenzenes make a notable contribution to the total peak percentage for the bio-oils extracted from birch and pine bark. Phenols with a methoxy group are the most abundant phenolic constituents compared to the other types of phenols in walnut shell and fir oil. The content of phenols without a methoxy group in the bio-oils from coconut husk and peanut shell is higher than the MeO and DHB concentrations. Therefore, it is expected that the efficacy of these plant-based bio-oils at delaying long-term oxidative aging will be controlled by the dominant type of phenolic compounds in each. For this reason, understanding the antioxidant activity of phenols from three categories (w/o MeO, MeO, and DHB) facilitates interpretation of the different behavior of plant-based bio-oils in improving asphalt's durability and increasing its resistance against oxidative aging. In this respect, representative phenolic molecules were considered here to examine their electronic properties and antioxidant reactivity parameters.

TABLE 13
The main individual phenolic compounds of
plant-based bio-oils identified by GC-MS.

| | | | | Wal- | Pea- | Coco- |
|---|---|---|---|---|---|---|
| | | Pine | | nut | nut | nut |
| Compounds (wt. %) | Fir | Bark | Birch | Shell | Shell | Husk |
| Phenols without | | | | | | |
| Methoxy Group (w/o MeO) | | | | | | |
| Phenol | 1.84 | 2.25 | 1.83 | 6.02 | 2.69 | 8.64 |
| Methylphenol | 0.74 | 1.24 | 0.75 | 1.62 | 1.40 | 1.98 |
| Dimethylphenol | 1.28 | 0.81 | 0.16 | 0.28 | 0.55 | 0.63 |
| Other phenols | 0.32 | 0.27 | — | 2.11 | 1.18 | 0.76 |
| | 4.18 | 4.57 | 2.75 | 10.03 | 5.82 | 12.01 |
| Phenols with Methoxy | | | | | | |
| Group (MeO) | | | | | | |
| o-guaiacol | 4.50 | 0.68 | 0.63 | 2.13 | 0.64 | 1.14 |
| p-methylguaiacol | 4.06 | 0.30 | 0.53 | 0.11 | 1.01 | 0.42 |
| p-vinylguaiacol | 0.77 | 1.16 | 0.42 | 1.15 | 0.24 | 1.88 |
| trans-p-propenylguaiacol | 3.52 | 1.29 | 0.04 | 0.80 | 0.15 | 0.11 |
| p-allylguaiacol | 1.10 | 0.35 | 0.46 | 1.13 | 0.03 | 0.47 |
| Syringol | — | — | 1.09 | 0.86 | 0.03 | 1.01 |
| Vaniline | — | — | 0.42 | 3.65 | 0.22 | 0.36 |
| Other methoxy phenols | 1.48 | 2.27 | 0.25 | 2.60 | 0.43 | 0.71 |
| | 15.43 | 6.05 | 3.84 | 12.43 | 2.75 | 6.10 |
| Dihydroxybenzene (DHB) | | | | | | |
| Catechol | 2.81 | 30.90 | 0.74 | 4.73 | 0.38 | 6.99 |
| 3-methyl-1,2-benzenediol | — | 0.33 | 2.99 | 2.62 | — | 0.11 |
| 4-methyl-1,2-benzenediol | 2.75 | 10.79 | 0.49 | — | — | 0.90 |
| | 5.56 | 42.03 | 4.22 | 7.35 | 0.38 | 8.01 |

Table 14 show the total phenolic compounds (wt. %) for each of the sources in Table 13. FIG. 2 show the relative concentration of the three categories of phenolic compounds in the bio-oils in Table 13.

TABLE 14
Total phenolic compounds from Table 13

| | | Pine | | Walnut | Peanut | Coconut |
|---|---|---|---|---|---|---|
| | Fir | Bark | Birch | Shell | Shell | Husk |
| Total Phenolic | 25.17 | 52.65 | 10.81 | 29.81 | 8.95 | 26.12 |
| compounds (wt. %) | | | | | | |

Nine phenolic compounds (w/o MeO (2), MeO (5), and DHB (2)) from bio-oils were investigated by quantum-based computational methods to elucidate their relationships between structure and antioxidant activity. Thermodynamic and electronic parameters to describe their radical-scavenging reactivity were calculated at B3LYP/6-31G (d) level of theory. Further, the effects of substituents such as phenolic hydroxyl (O—H), methoxy (O—CH₃), carbonyl (C═O), and unsaturated hydrocarbon chain (—C═C) groups on the antioxidant activity of phenolic compounds and the electronic mechanisms of these effects were investigated. To determine the reactivity of phenolic compounds to delay asphalt oxidative aging, their hydrogen-donating capability through a hydrogen-transfer (HT) mechanism was evaluated.

A HT mechanism is a one-step reaction related to the O—H bond dissociation enthalpy (Equation 17). BDE is a numerical descriptor that is associated with the stability of an O—H bond, describing the hydrogen-donation capability of phenolic compounds and the formation of a stable phenoxy radical. Phenoxy radicals are important intermediates in relation to the antioxidant activity of phenols. Indeed, there is a correlation between the capability of phenolic compounds in hydrogen transferring and the production of phenoxy radicals to quench more free radicals generated during oxidative aging. A lower BDE value characterizes higher hydrogen-donating tendency and better free-radical scavenging.

$$ArOH + ROO \cdot \to ArO + ROOH \qquad ( 17 )$$

The calculated O—H BDE values for the identified phenolic compounds are reported in Table 15. In parallel, the BDE values for the nine phenolic representatives available in plant-based bio-oils have been plotted to provide insight into the trend ruling the antioxidant activity of phenolic compounds in the six bio-oils. Dihydroxybenzenes were found have the highest hydrogen-donating ability (the least BDE values) and phenols without methoxy group have the least hydrogen-donating ability (the highest BDE values). This means that the capability for antioxidant activity of the three different types of phenolic compounds is as follows: dihydroxybenzenes (DHBs)>phenols with methoxy group (MeOs)>phenols without methoxy group (w/o MeOs).

BDE values are governed at least in part by the stability of a phenolic compound and the stability of a phenoxy radical. The electronic effects that influence the stability of a phenolic compound and its phenoxy radical mainly include the conjugation effect, the induction effect, and spin delocalization of the unpaired electron. Phenol (w/o MeO—2) is placed in the list of representative molecules as a common segment and antioxidant-activity center in all phenolic compounds, to evaluate the effect of substituents on the BDE values. Based on the BDE values reported in Table 15, the introduction of the phenolic hydroxyl group (OH) and the methoxy group (OCH₃) reduces the OH BDE of phenolic compounds that corresponds to lower stability of OH and higher antioxidant activity. Compared with w/o MeO—1 and w/o MeO—2, the BDE values of DHBs and MeOs decrease, and the BDEs of DHB-1 and DHB-2 are the lowest values in this table. The hydroxyl group (O—H) is more effective in comparison with the methoxy group (O—Me) to enhance the antioxidant activity of phenolic compounds. The BDE of DHB-1 is 5.0 kcal/mol lower than that of MeO—3. The only difference between molecular structures for DHB-1 and MeO—3 is replacing the OH group in DHB-1 by an OCH₃ group leading MeO—3. The hydroxyl group is an electron donor group that can form an intramolecular hydrogen bond with the oxygen atom carrying the unpaired electron in a phenoxy radical produced in the HT mechanism and stabilize it. This electronic behavior of a hydroxyl group enhances the antioxidant activity of the other O—H in a phenolic compound. Although the methoxy group improves the antioxidant activity of phenolic compounds, the presence of a carbonyl group (C═O) in MeO—5 increases the stability of the corresponding O—H bond and its BDE value (75.6 kcal/mol), indicating that the OH bond is not easily broken. MeO—5 has the highest BDE value among the other molecules from the category of phenolics with a methoxy group. This may be related to the induction effect: —C═O is considered to be an electron withdrawing group that increases the O—H bond dissociation energy of MeO—5, which is about 3.3 kcal/mol higher than that of MeO—3 and about 4.7 kcal/mol higher than that of MeO—1. The BDE value is also influenced by the overall hydrocarbon framework of the phenolic compound and the conjugation and delocalization of an unpaired electron after hydrogen transferring, which can directly reflect the hydrogen-donation capability of a phenolic compound. The unsaturated substituents, —CH₂—CH═CH₂ and —CH═CH₂, in MeO—1 and MeO—2 reduce the BDE value of phenolic compounds with a methoxy group by about 3.0 kcal/mol on average, which indicates that —CH₂—CH═CH₂ and —CH═CH₂ significantly favor a conjugation and resonance effect on the para oxygen-center radical.

Experimental results for the PAV aging index of bio-modified asphalt show that there is a correlation between the effectiveness of bio-oils and their phenolic content. In general, phenol-rich bio-oils show high efficacy to delay oxidative aging; a higher concentration of phenols indicates stronger antioxidant activity. The low aging index for asphalt modified by pine-bark bio-oil is evidence to support this hypothesis. However, the molecular structure of the dominant type of phenolic compounds in each bio-oil and the electronic nature of their substituents are the other key factors determining the antioxidant effectiveness of a bio-oil. Based on our computational results, the effectiveness of bio-oils from birch and pine bark in delaying asphalt oxidative aging may be related to the presence of phenolic compounds with two hydroxyl groups (dihydroxybenzenes) in high concentrations. Oils from the pyrolysis of fir and walnut shell show relatively good performance in increasing the resistance of asphalt against factors responsible for oxidative aging due to their high content of phenols with methoxy groups. Finally, the absence of a methoxy group and the second hydroxyl group in the molecular structure of predominant phenolic compounds detected in coconut husk and peanut shell makes them less-efficient candidates to be modifiers to improve asphalt durability against long-term aging.

TABLE 15
The calculated bond dissociation enthalpies,
BDEs (kcal/mol), for nine tested phenolic compounds
in gas phase at B3LYP/6-31 (d) level.

| Phenolic compounds | Abbreviation | Formula | BDE |
|---|---|---|---|
| 4-methyl-1,2-benzenediol | DHB-1 | C₇H₈O₂ | 67.3 |
| Catechol | DHB-2 | C₆H₆O₂ | 69.1 |
| p-allylguaiacol | MeO-1 | C₁₀H₁₂O₂ | 70.9 |
| p-vinylguaiacol | MeO-2 | C₉H₁₀O₂ | 71.2 |
| p-methylguaiacol | MeO-3 | C₈H₁₀O₂ | 72.3 |
| Syringol | MeO-4 | C₈H₁₀O₃ | 74.4 |
| Dimethylphenol | w/o MeO-1 | C₈H₁₀O | 74.8 |
| Vaniline | MeO-5 | C₈H₈O₃ | 75.6 |
| phenol | w/o MeO-2 | C₆H₆O | 79.1 |

The efficacy of various bio-oils such as phenol-rich plant-based bio-oils to delay aging of asphalt pavements exposed to oxidation and ultraviolet exposure has been shown. A summary of the best bitumen samples at different aging conditions for various aging parameters is provided in Table 16.

TABLE 16
Best anti-aging bitumen samples for different
aging types at various aging parameters

| | | Unaged | | | |
|---|---|---|---|---|---|
| | Unaged | (sur- | | | |
| | (bulk) | face) | RTFO | PAV | UV |
| Carbonyl Index | NEAT | CH | NEAT | NEAT | CH |
| Sulfoxide Index | PB | NEAT | NEAT | PS | CH |
| AI (Carbonyl Index) | — | — | CH | BR | BR |
| AI (Sulfoxide Index) | — | — | CH | FR | CH |
| Modified AI (Carbonyl | — | — | — | BR | — |
| Index) | | | | | |
| Modified AI (Sulfoxide | — | — | — | PS | — |
| Index) | | | | | |
| Chemical Aging Index | — | — | PS | WS | CH |
| Activation Energy | CH | — | NEAT | FR | — |
| AI (Activation Energy) | — | — | NEAT | WS | — |
| Modified AI (Activation | — | — | — | PB | — |
| Energy) | | | | | |
| Adhesion Strength | — | WS | — | — | NEAT |
| AI (Adhesion Strength) | — | — | — | — | NEAT |
| Crossover Modulus | NEAT | — | NEAT | NEAT | — |
| Crossover Frequency | BR | — | NEAT | CH | — |
| AI (Crossover Modulus) | — | — | PB | NEAT | — |
| AI (Crossover | — | — | CH | NEAT | — |
| Frequency) | | | | | |
| Modified AI (Crossover | — | — | — | NEAT | — |
| Modulus) | | | | | |
| Modified AI (Crossover | — | — | — | PS | — |
| Frequency) | | | | | |

Thus, it has been shown that incorporating certain bio-oils in asphalt binder can lead to delayed aging and consequently more durable pavements. The superior performance of bio-oil-modified binder was most apparent in the long-term oxidative-aged samples and long-term UV-aged samples.

All bio-oils were effective at inhibiting carbonyl increase after long-term aging. In terms of delaying sulfoxide formation, compared to neat binder, FR was the most effective, (showing 94.1% lower sulfoxide) and PS was the least effective (showing 21.1% lower sulfoxide) after long-term oxidative aging.

Bio-oils showed superior performance in terms of chemical aging for UV-aged samples, indicating up to a 69% reduction in the chemical index compared to neat binder.

The FR bio-oil sample showed the lowest activation energy value after long-term oxidative aging, nearly 11% lower than the neat binder, while WS was nearly 84% more effective than neat binder at limiting activation energy increase. BR and FR oil showed lower activation energy values after long-term aging than their respective unaged samples.

Although neat binder displayed the highest values for the crossover-modulus aging index and the crossover-frequency aging index, WS showed superior crossover frequency results after long-term oxidative aging, being 41% larger than the neat binder.

The computational analyses support the hypothesis that bio-oils with a high content of phenolic compounds could be more effective to delay long-term oxidative aging. This in turn can be influenced by the molecular structure of the dominant phenolic compounds and their substituents that can directly reflect the hydrogen-donation capability of phenolic compounds to quench free radicals.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A bio-modified asphalt binder comprising:
an asphalt binder; and
a phenol-rich oil comprising about 5 wt % to about 75 wt % phenolic compounds.

2. The bio-modified asphalt binder of claim 1, wherein the phenol-rich oil comprises a bio-oil comprising phenolic compounds.

3. The bio-modified asphalt binder of claim 1, wherein the bio-oil is derived from pine bark.

4. The bio-modified asphalt binder of claim 1, wherein the bio-oil is derived from walnut shells.

5. The bio-modified asphalt binder of claim 1, wherein the bio-oil is derived from peanut shells.

6. The bio-modified asphalt binder of claim 1, wherein the bio-oil is derived from coconut husks.

7. The bio-modified asphalt binder of claim 1, wherein the bio-oil is derived from birch.

8. The bio-modified asphalt binder of claim 1, wherein the bio-oil is derived from fir.

9. The bio-modified asphalt binder of claim 1, wherein the bio-modified asphalt binder comprises the phenol-rich oil in a range of about 5 wt % to about 15 wt %.

10. The bio-modified asphalt binder of claim 1, wherein the phenolic compounds comprise phenol, methylphenol, dimethylphenol, o-guaiacol, p-methylguaiacol, p-vinylguaiacol, trans-p-propenylguaiacol, p-allylguaiacol, syringol, vaniline, catechol, 3-methyl-1,2-benzenediol, 4-methyl-1,2-benzenediol, or any combination thereof.

11. The bio-modified asphalt binder of claim 1, wherein the phenol-rich oil comprises phenol in a range of about 1 wt % to about 9 wt %.

12. The bio-modified asphalt binder of claim 1, wherein the phenol-rich oil comprises methylphenol in a range of about 0.5 wt % to about 2 wt %.

13. The bio-modified asphalt binder of claim 1, wherein the phenol-rich oil comprises dimethylphenol in a range of about 0.1 wt % to about 2 wt %.

14. The bio-modified asphalt binder of claim 1, wherein the phenol-rich oil comprises o-guaiacol in a range of about 0.5 wt % to about 5 wt %.

15. The bio-modified asphalt binder of claim 1, wherein the phenol-rich oil comprises p-methylguaiacol in a range of about 0.1 wt % to about 5 wt %.

16. The bio-modified asphalt binder of claim 1, wherein the phenol-rich oil comprises p-vinylguaiacol in a range of about 0.5 wt % to about 2 wt %.

17. The bio-modified asphalt binder of claim 1, wherein the phenol-rich oil comprises trans-p-propenylguaiacol in a range of about 0.1 wt % to about 4 wt %.

18. The bio-modified asphalt binder of claim 1, wherein the phenol-rich oil comprises p-allylguaiacol in a range of about 0.01 wt % to about 2 wt %.

19. The bio-modified asphalt binder of claim 1, wherein the phenol-rich oil comprises less than about 2 wt % syringol.

20. The bio-modified asphalt binder of claim 1, wherein the phenol-rich oil comprises less than about 4 wt % vaniline.

21. The bio-modified asphalt binder of claim 1, wherein the phenol-rich oil comprises catechol in a range of about 0.1 wt % to about 7 wt %.

22. The bio-modified asphalt binder of claim 1, wherein the phenol-rich oil comprises less than about 3 wt % 3-methyl-1,2-benzenediol.

23. The bio-modified asphalt binder of claim 1, wherein the phenol-rich oil comprises less than about 11 wt % 4-methyl-1,2-benzenediol.

24. The bio-modified asphalt binder of claim 1, wherein the phenol-rich oil comprises about 5 wt % to about 60 wt % phenolic compounds.

25. The bio-modified asphalt binder of claim 1, wherein the phenol-rich oil comprises about 10 wt % to about 60 wt % phenolic compounds.

26. The bio-modified asphalt binder of claim 1, wherein the phenol-rich oil comprises about 25 wt % to about 60 wt % phenolic compounds.

27. The bio-modified asphalt binder of claim 1, wherein the phenol-rich oil comprises about 50 wt % to about 60 wt % phenolic compounds.

28. The bio-modified asphalt binder of claim 1, wherein the phenol-rich oil comprises about 50 wt % to about 55 wt % phenolic compounds.

29. A building material comprising the bio-modified asphalt binder of claim 1.

30. A bio-modified asphalt comprising:
the bio-modified asphalt binder of claim 1; and
aggregate material.

31. The bio-modified asphalt of claim 30, wherein the aggregate material comprises one or more of rock, sand, gravel, and slags.

32. A building material comprising the bio-modified asphalt of claim 30.
